(19) United States
(12) Patent Application Publication
(10) Pub. No.: US 2026/0170034 A1
(43) Pub. Date: Jun. 18, 2026

(54) ELECTRONIC DEVICE FOR SEARCHING FOR NOTE CONTENT AND METHOD THEREOF

(71) Applicant: Samsung Electronics Co., Ltd., Suwon-si (KR)

(72) Inventors: Dohyeon KIM, Suwon-si (KR); Soonsang PARK, Suwon-si (KR); Minji SON, Suwon-si (KR); Jeongpyo LEE, Suwon-si (KR); Junseok LEE, Suwon-si (KR); Yonggil HAN, Suwon-si (KR)

(21) Appl. No.: 19/532,164

(22) Filed: Feb. 6, 2026

Related U.S. Application Data
(63) Continuation of application No. PCT/KR2024/013357, filed on Sep. 4, 2024.

(30) Foreign Application Priority Data
Oct. 20, 2023 (KR) 10-2023-0141580
Nov. 14, 2023 (KR) 10-2023-0157710

(51) Int. Cl. G06F 16/334; G06F 16/338; G06F 16/353; G06F 40/279; G06V 30/32

(52) U.S. Cl. CPC G06F 16/3344; G06F 16/338; G06F 16/353; G06F 40/279; G06V 30/347

(57) ABSTRACT

An electronic device may: receive an input for searching for note contents stored in a memory, the input may include at least one of a piece of text input through a virtual keyboard or a path of an external object dragged on a display; determine, based on identifying a first piece of text from an input, one or more second pieces of text, which appear to be related to the first piece of text, using a language model representing a relationship between words; determine feature information of one or more paths based on identifying the one or more paths from the input; execute a function for searching a database related to note contents using at least one of the one or more second pieces of text and the feature information; and display a screen providing at least one note content on the display in response to at least one note content matched with the input, identified based on the execution of the function.

### CROSS-REFERENCE TO RELATED APPLICATIONS

This application is a continuation of International Application No. PCT/KR2024/013357 designating the United States, filed on Sep. 4, 2024, in the Ministry of Intellectual Property and claiming priority to Korean Patent Application Nos. 10-2023-0141580, filed on Oct. 20, 2023, and 10-2023-0157710, filed on Nov. 14, 2023, in the Ministry of Intellectual Property, the disclosures of each of which are incorporated by reference herein in their entireties.

### BACKGROUND

### Field

The disclosure relates to an electronic device for searching for a note content and a method thereof.

### Description of Related Art

An electronic device that extracts a text from handwriting indicated by strokes drawn by a user is being developed. For example, the user may draw strokes indicating handwriting by moving a finger, a stylus, and/or a digitizer contacted on a display of the electronic device, or by moving a pointing device (e.g., a mouse) connected to the electronic device. From the strokes, the electronic device may identify a letter such as an alphabet. Based on identifying one or more characters, the electronic device may identify a text including the one or more characters.

The above-described information may be provided as a related art for the purpose of helping understanding of the present disclosure. No assertion or determination is made as to whether any of the above description may be applied as a prior art related to the present disclosure.

### SUMMARY

According to an example embodiment, an electronic device may comprise: a display, memory comprising one or more storage media storing instructions, and at least one processor comprising processing circuitry, wherein at least one processor, individually and/or collectively, may be configured to execute the instructions and to cause the electronic device to: receive an input to search note contents stored in the memory, wherein the input may include at least one of texts input through a virtual keyboard and a path of an external object dragged on the display; based on identifying a first text from the input, determine one or more second texts indicated as associated with the first text using a language model representing a relationship between words; based on identifying one or more paths from the input, determine feature information of the one or more paths; using at least one of the one or more second texts or the feature information, execute a function to search a database associated with the note contents; and in response to at least one note content matched to the input identified based on execution of the function, display, on the display, a screen providing the at least one note content.

According to an example embodiment, a method of operating an electronic device comprising a display, memory and at least one processor, comprising processing circuitry, is provided. The method may comprise: receiving an input to search note contents stored in the memory, wherein the input may include at least one of texts input through a virtual keyboard and a path of an external object dragged on the display; based on identifying a first text from the input, determining one or more second texts indicated as associated with the first text using a language model representing a relationship between words; based on identifying one or more paths from the input, determining feature information of the one or more paths; using at least one of the one or more second texts or the feature information, executing a function to search a database associated with the note contents; and in response to at least one note content matched to the input identified based on execution of the function, displaying, on the display, a screen providing the at least one note content.

According to an example embodiment, an electronic device may comprise a display, memory, and at least one processor comprising processing circuitry, wherein at least one processor, individually and/or collectively, may be configured to cause the electronic device to: receive an input to search a plurality of note contents stored in the memory using a first word; determine one or more second words where at least one word included in the first word is replaced using a language model representing a relationship between words; execute a function to search at least one note content among the plurality of note contents including at least one of the first word or the one or more second words represented by texts or one or more strokes; and display, on the display, a screen providing the identified at least one note content based on execution of the function.

According to an example embodiment, a method of operating an electronic device comprising a display, memory and at least one processor, comprising processing circuitry, is provided. The method may comprise: receiving an input to search a plurality of note contents stored in the memory using a first word; determining one or more second words where at least one word included in the first word is replaced using a language model representing a relationship between words; executing a function to search at least one note content among the plurality of note contents including at least one of the first word or the one or more second words represented by texts or one or more strokes; and displaying, on the display, a screen providing the identified at least one note content based on execution of the function.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example user interface (UI) of an electronic device displayed to search note contents stored in memory according to various embodiments.

FIG. 2 is a block diagram illustrating an example configuration of an electronic device according to various embodiments.

FIG. 3 is a diagram illustrating an example operation of an electronic device that manages a database associated with a note content stored in memory according to various embodiments.

FIG. 4 is a flowchart illustrating an example operation of an electronic device according to various embodiments.

FIG. 5 is a diagram illustrating an example operation of an electronic device for identifying elements included in a note content according to various embodiments.

FIG. 6 is a diagram illustrating an example operation of an electronic device that manages a database associated with a handwriting object included in note contents according to various embodiments.

FIG. 7 is a diagram illustrating an example operation of an electronic device for clustering note contents using a handwriting object included in the note contents according to various embodiments.

FIG. 8 is a diagram illustrating an example operation of an electronic device that manages a database associated with note contents based on clustering of the note contents according to various embodiments.

FIG. 9 is a diagram illustrating an example operation of an electronic device for searching note contents including a handwriting object using a database generated using the handwriting object according to various embodiments.

FIGS. 10A and 10B are diagrams illustrating an example operation of an electronic device that performs searching of note contents using one or more strokes indicated by a user input according to various embodiments.

FIG. 11 is a diagram illustrating an example operation of an electronic device that performs searching of note contents using feature information of one or more strokes indicated by a user input according to various embodiments.

FIGS. 12A, 12B, 12C, and 12D are diagrams illustrating example operations of an electronic device that has received each of example user inputs according to various embodiments.

FIG. 13 is a block diagram of an example electronic device in a network environment according to various embodiments.

### DETAILED DESCRIPTION

Hereinafter, various example embodiments of the disclosure will be described in greater detail with reference to the accompanying drawings.

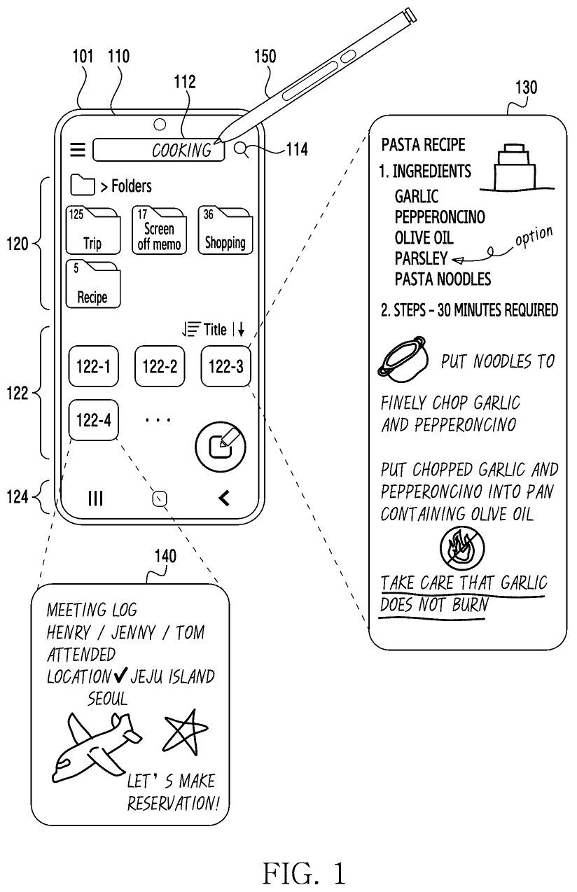

FIG. 1 is a diagram illustrating an example user interface (UI) of an electronic device 101 displayed to search note contents stored in memory according to various embodiments. In an embodiment, in terms of being owned by a user, the electronic device 101 may be referred to as a terminal (or a user terminal). The terminal may include, for example, a personal computer (PC) such as a laptop and a desktop. The terminal may include, for example, a smartphone, a smart pad, and/or a tablet PC. The terminal may include a smart accessory such as a smartwatch and/or a head-mounted device (HMD).

Referring to FIG. 1, an example screen displayed on a display 110 is illustrated. Hereinafter, the screen may refer to a user interface (UI) displayed in at least a portion of the display 110. The screen may include, for example, a window of the Windows operating system and/or an activity of the Android operating system. However, the disclosure is not limited thereto, and the screen may be formed in an external space by light output from the electronic device 101 to the external space. For example, within the external space, the screen may be formed on a plane on which the light is projected. For example, the screen may be displayed three-dimensionally in a form of a hologram within the external space. The screen displayed on the display 110, illustrated in FIG. 1, may be displayed by the electronic device 101 that has executed a software application (hereinafter referred to as a note application) for managing a note content.

Hereinafter, the note content may include writings that are digitized information stored in the electronic device 101. The note content may include, for example, text, an image, a video, an audio, or any combination thereof. Elements included in the note content are not limited to the above example and may include one or more strokes representing handwriting (or hand-drawing).

Hereinafter, a stroke may refer, for example, to a movement route, path, or trajectory of an external object (e.g., a fingertip of the user and/or a stylus pen 150) contacted on the display 110. For example, a character “+” drawn on the display 110 using the stylus pen 150 may include a first stroke that is a path in a vertical direction of the stylus pen 150 contacted on the display 110, and a second stroke that is a path in a horizontal direction of the stylus pen 150 contacted on the display 110.

In an embodiment, while the stylus pen 150 is contacted on the display 110 once, the electronic device 101 may detect a first point on the display 110 at which the stylus pen 150 is contacted initially, second points indicating positions of the stylus pen 150 contacted on the display 110 at each of timings after the first point, and a third point on the display 110 at which the stylus pen 150 is contacted last. By connecting the first point, the second points, and the third point according to an order of timings in which the points are detected, the electronic device 101 may detect one stroke.

For example, information corresponding to the one stroke may include coordinate values of the first point, the second points, and the third point, and/or timing at which the first point, the second points, and the third point are detected. The disclosure is not limited thereto, and the information corresponding to the one stroke may include numerical values (e.g., index values) indicating an order of the first point, the second points, and the third point.

In an embodiment, the elements included in the note content may be arranged in a two-dimensional coordinate space referred to as a page, a note and/or a canvas. In an embodiment, the electronic device 101 may provide a user experience, such as handling a physical notebook, to the user using the note content provided through the display 110.

Referring to FIG. 1, example note contents 130 and 140 stored in the electronic device 101 are illustrated. The note contents 130 and 140 may include one or more characters received through a virtual keyboard (or a real keyboard connected wirelessly and/or by wire to the electronic device 101). The one or more characters may correspond to binary codes, which are included in the note contents 130 and 140, according to an encoding standard such as Unicode (or American Standard Code for Information Interchange (ASCII)). An element of a note content based on the binary code, including a character (e.g., alphabet and/or number), an emoticon and/or a special character, may be referred to as text. The note content may include a handwriting object that is different from the text and visualizes at least one character and/or figure. The handwriting object may include one or more strokes indicated by a movement of the external object (e.g., the fingertip of the user and/or the stylus pen 150) contacted on the display 110.

In an embodiment, management of the note content supported by the electronic device 101 may include generation (or storage), transmission (e.g., sharing), change, deletion and/or search of the note content. Referring to FIG. 1, an example screen displayed on the display 110 is illustrated for browsing of one or more note contents stored in the electronic device 101. The screen may include a navigation bar 124 including executable objects for switching of a screen displayed on the display 110. The screen may include a region 120 for displaying a list of groups (e.g., a folder and/or a directory) capable of accommodating the one or more note contents. The screen may include a region 122 for displaying visual objects (e.g., a preview image and/or a thumbnail) 122-1, 122-2, 122-3, and 122-4 corresponding to each of the note contents stored in the electronic device 101.

Referring to FIG. 1, the example screen displayed on the display 110 may include a region 112 for receiving search criteria for searching of the note contents stored in the electronic device 101. The search criteria may be referred to as a query. The region 112 may include a visual object linked with the virtual keyboard, such as a text box. Together with the region 112, the electronic device 101 may display a visual object 114 for initiating searching of the note contents. For example, through the visual object 114 including a magnifying glass-shaped icon, the electronic device 101 may receive an input indicating completion of an input of the search criteria through the region 112. In response to an input indicating selection of the visual object 114, the electronic device 101 may execute a function for searching a note content matching the search criteria input through the region 112.

Hereinafter, a visual object may refer, for example, to a deployable object that may be disposed in a screen for transmission and/or interaction of information, such as text, an image, an icon, a video, a button, a check box, a radio button, a text box, a slider, and/or a table. The visual object may be referred to as a visual element, a UI element, a view object, and/or a view element.

In an embodiment, search criteria that the electronic device 101 may receive through the region 112 may include text input through the virtual keyboard. The electronic device 101 may include a handwriting object including one or more strokes by tracking a path of an external object (e.g., a finger, the fingertip, and/or the stylus pen 150) contacted on the region 112. Referring to FIG. 1, in an embodiment detecting strokes (e.g., strokes representing handwriting such as “cooking”) input into the region 112 by the stylus pen 150, the electronic device 101 may execute a function for searching of the note contents using a first word (e.g., “cooking”) recognized by the strokes, one or more second words similar to the first word, and/or a shape of the strokes included in the handwriting object.

Referring to FIG. 1, the example note contents 130 and 140 are illustrated. For example, the note content 130 may include text and a handwriting object associated with a recipe. For example, the note content 140 may include a handwriting object associated with a meeting log. In an embodiment of receiving a handwriting object (e.g., strokes representing handwriting such as “cooking”) through at least one portion (e.g., the region 112) of the display 110 of the electronic device 101, the electronic device 101 does not include the first word (e.g., “cooking”) recognized from the handwriting object, but may display the note content 130 including the second words (e.g., “recipe,” “pasta,” and/or “garlic”) similar to the first word on the display 110 as a result corresponding to the received handwriting object (or the search criteria).

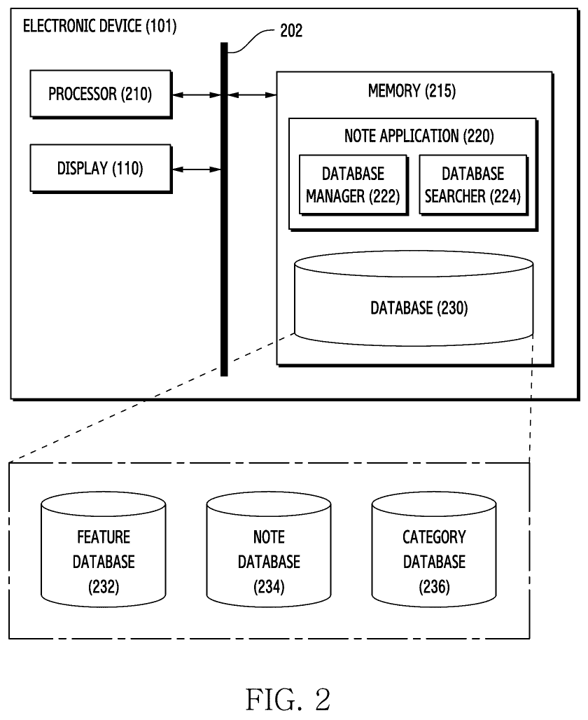

As described above, according to an embodiment, the electronic device 101 may receive an input (e.g., a user input) for searching the note contents stored in the memory. The user input may include at least one of text input through a virtual keyboard or a path of an external object (e.g., the stylus pen 150) dragged on the display. The electronic device 101 may search for a note content that meets search criteria indicated by the user input. Like an example state illustrated in FIG. 1, the electronic device 101 receiving the search criteria based on a handwriting object may search the note content that meets the search criteria using a database generated by analyzing the handwriting object of the note contents 130 and 140. Hereinafter, an example hardware configuration of the electronic device 101 including the database will be described in greater detail with reference to FIG. 2.

FIG. 2 is a block diagram illustrating an example configuration of an electronic device 101 according to various embodiments. The electronic device 101 of FIG. 2 may include the electronic device 101 of FIG. 1.

Referring to FIG. 2, according to an embodiment, the electronic device 101 may include at least one of a processor (e.g., including processing circuitry) 210, memory 215, and a display 110. The processor 210, the memory 215, and the display 110 may be electronically and/or operably coupled with each other by an electronic component such as a communication bus 202. Hereinafter, hardware components being operably coupled may refer, for example, to a direct connection or an indirect connection between the hardware components being established by wire or wirelessly so that a second hardware component is controlled by a first hardware component among the hardware components. Although illustrated based on different blocks, the disclosure is not limited thereto, and a portion (e.g., at least a portion of the processor 210 and the memory 215) of the hardware components of FIG. 2 may be included in a single integrated circuit such as a system on a chip (SoC). A type and/or the number of the hardware components included in the electronic device 101 is not limited as illustrated in FIG. 2. For example, the electronic device 101 may include only a portion of the hardware components illustrated in FIG. 2.

The processor 210 of the electronic device 101 according to an embodiment may include various processing circuitry, such as, a hardware component for processing data based on one or more instructions. For example, the hardware component for processing data may include an arithmetic and logic unit (ALU), a floating point unit (FPU), a field programmable gate array (FPGA), a central processing unit (CPU), and/or an application processor (AP). The number of processors 210 may be one or more. For example, the processor 210 may have a structure of a multi-core processor such as a dual core, a quad core, a hexa core, or an octa core. Thus, the processor 210 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The memory 215 of the electronic device 101 according to an embodiment may include a hardware component for storing data and/or instructions input into the processor 210 or output from the processor 210. The memory 215 may include, for example, a volatile memory such as a random-access memory (RAM) and/or a non-volatile memory such as a read-only memory (ROM). The volatile memory may include, for example, at least one of a dynamic RAM (DRAM), a static RAM (SRAM), a cache RAM, and a pseudo SRAM (PSRAM). The non-volatile memory may include, for example, at least one of a programmable ROM (PROM), an erasable PROM (EPROM), an electrically erasable PROM (EEPROM), a flash memory, a hard disk, a compact disk, a solid state drive (SSD), and an embedded multimedia card (eMMC).

The display 110 of the electronic device 101 according to an embodiment may output visualized information (for example, the screen of FIG. 1) to a user. For example, the display 110 may be configured to visualize information provided from a graphic processing unit (GPU) and/or the processor 210. The display 110 may include a liquid crystal display (LCD), a plasma display panel (PDP), and/or one or more light emitting diodes (LEDs). The LED may include an organic LED (OLED). The display 110 may include a flat panel display (FPD) and/or electronic paper. The disclosure is not limited thereto, and the display 110 may have at least a partially curved shape or a deformable shape. The display 110 having the deformable shape may be referred to as a flexible display.

The display 110 of the electronic device 101 according to an embodiment may include a sensor (e.g., a touch sensor panel (TSP)) for detecting an external object (e.g., a finger of the user) on the display 110. For example, based on the TSP, the electronic device 101 may detect the external object contacting the display 110 or floating on the display 110. In response to detecting the external object, the electronic device 101 may execute a function associated with a specific visual object corresponding to a position of the external object on the display 110 among visual objects displayed in the display 110.

The display 110 of the electronic device 101 according to an embodiment may include a panel (e.g., a digitizer) for detecting the stylus pen 150 of FIG. 1. The stylus pen adjacent to the display 110 may include circuitry activated by a magnetic field (or an electric field) formed by the panel. Using the circuitry, the stylus pen may transmit a signal for detecting a position of the stylus pen on the display 110. Using the signal, the processor 210 may calculate or determine the position of the stylus pen floating on the display 110 and/or contacting the display 110.

Although not illustrated, the electronic device 101 may include an output device for outputting information in a form other than the visualized form. For example, the electronic device 101 may include a speaker for outputting an acoustic signal. For example, the electronic device 101 may include a motor for providing haptic feedback based on vibration.

Referring to FIG. 2, in the memory 215, one or more instructions (or commands) indicating a calculation and/or an operation to be performed by the processor 210 on data may be stored. A set of the one or more instructions may be referred to as firmware, an operating system, a process, a routine, a sub-routine, and/or a software application (hereinafter, an application). For example, the electronic device 101 and/or the processor 210 may perform at least one of operations described with reference to FIGS. 1 to 13 when a set of a plurality of instructions distributed in a form of an operating system, firmware, a driver, and/or an application is executed. In the following, an application being installed on the electronic device 101 may refer, for example, to one or more instructions provided in a form of the application being stored in the memory 215 of the electronic device 101, and that the one or more applications are stored in an executable format (e.g., a file with an extension designated by the operating system of the electronic device 101).

Referring to FIG. 2, a note application 220 is illustrated as an example application installed in the memory 215 of the electronic device 101. The note application 220 may include a function and/or a sub-routine for managing a database 230 associated (or linked) with note contents (e.g., the note contents 130 and 140 of FIG. 1) stored in the memory 215. Referring to FIG. 2, one or more instances (e.g., a database manager 222 and/or a database searcher 224) included in the note application 220 are illustrated. An instance (or a process) may refer, for example, to a unit of one or more operations performed by the processor 210 executing a program such as the note application 220.

In an embodiment, the processor 210 may manage information (e.g., one or more note contents) stored in the memory 215 based on the database (DB) 230 stored in the memory 215. In an embodiment, the database 230 may include at least one of a set of systematized information to be shared between independent applications executed in the electronic device 101 and/or a plurality of electronic devices including the electronic device 101, or one or more applications managing the information. In the set of the information, different information may be combined with each other based on a unit such as a type, a column, a record, and/or a table. A combination of the information included in the database 230 may be referred to as a record, a tuple, and/or a row of the table. In the record, different types of data may be combined, based on different columns and/or features. The combination of the information may be used for adding, deleting, updating, and searching of the information within the database 230. For example, in a state in which the electronic device 101 searches information of a designated condition, the electronic device 101 may further identify information that satisfies the condition and/or other information combined with the information using the database 230.

Referring to FIG. 2, the processor 210 that has executed the note application 220 may manage the DB 230 including a feature DB 232, a note DB 234, and a category DB 236. The note DB 234 may be configured to store features of note contents stored in the memory 215. For example, the note DB 234 may include records linked with each of the note contents stored in the memory 215. The feature DB 232 may be configured to store information indicating a relationship between the note contents and a plurality of words (e.g., a word represented by one or more strokes). The feature DB 232 may include records linked with each of the plurality of words. The category DB 236 may be configured to store information for clustering (or classifying) the note contents stored in the memory 215 using a plurality of categories. The category DB 236 may include records linked with each of the plurality of categories.

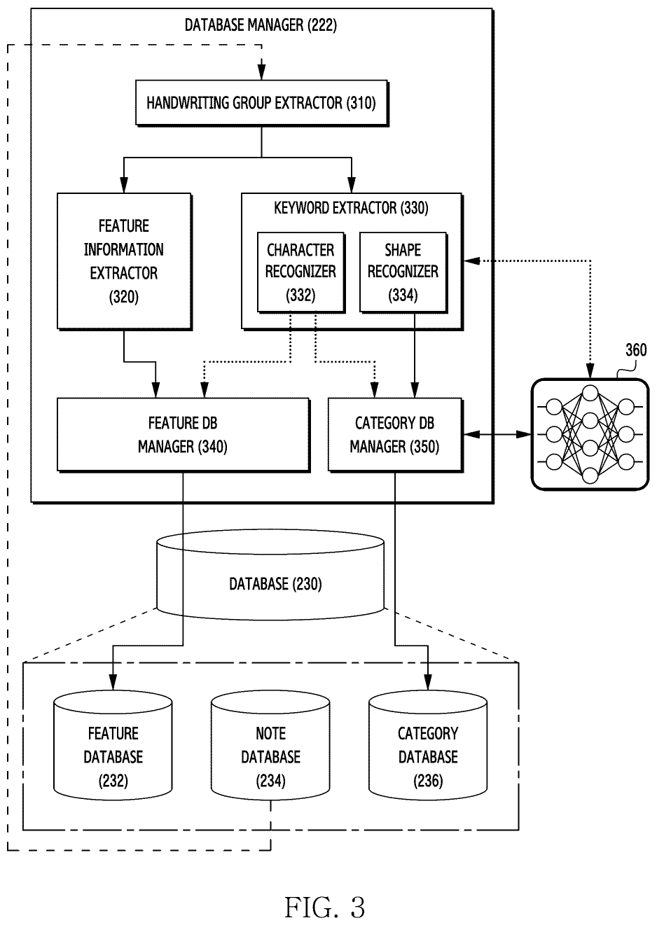

In an embodiment, the processor 210 may update the database 230 using the database manager 222 executed in a background state. The update of the database 230 may include an operation of updating the feature DB 232 and/or the category DB 236 using the updated note DB 234 according to addition, deletion, and/or change of note contents. The processor 210 may extract handwriting objects (e.g., at least one stroke configuring handwriting) included in the note contents. The processor 210 may determine a feature of the extracted handwriting objects (e.g., information indicating a shape of strokes included in a handwriting object, such as a handwriting style) and/or one or more characters associated with the handwriting objects. The processor 210 may update the feature DB 232 using one or more words associated with the extracted handwriting objects. In the feature DB 232, the processor 210 may store the feature of the handwriting objects. Using a relationship between the one or more words and categories, the processor 210 may update the category DB 236. An operation in which the processor 210 manages and/or updates information associated with the note contents using the DB 230 will be described in greater detail below with reference to FIGS. 3 to 8.

In an embodiment, the processor 210 may compare information included in the DB 230 with search criteria set by a user input using the database searcher 224. The processor 210 identifying a handwriting object indicated by the user input may extract a note content including the handwriting object from the feature DB 232 using a feature of the handwriting object and/or at least one word associated with the handwriting object. The processor 210 may search a note content included in a category associated with the at least one word from the category DB 236 using the at least one word associated with the handwriting object.

In an embodiment, an operation of updating the DB 230 by the processor 210 that has executed the database manager 222 may be referred to as an operation of indexing the note contents in terms of updating information used for searching of the note contents based on the database searcher 224. Hereinafter, an example operation of the processor 210 of indexing the note contents based on the execution of the database manager 222 will be described in greater detail with reference to FIG. 3.

FIG. 3 is a diagram illustrating an example operation of an electronic device that manages a database 230 associated with a note content stored in memory according to various embodiments. The operation of the electronic device described with reference to FIG. 3 may be performed by the electronic device 101 of FIGS. 1 and 2 and/or the processor 210 of FIG. 2. The operation of the electronic device described with reference to FIG. 3 may be performed based on execution of the database manager 222 of FIG. 2.

The electronic device according to an embodiment may perform indexing note contents (e.g., the note contents 130 and 140 of FIG. 1) by executing the database manager 222 in a background state. The database manager 222 may be executed at a timing when a note content is added, deleted and/or changed. The database manager 222 may be executed at a timing when a resource occupied by another software application executed in a state (e.g., a foreground state) different from the background state is relatively reduced. For example, database manager 222 may be executed in a different time duration (e.g., late at night) than a time duration expected that execution of a software application by a user will occur frequently. The database manager 222 may be executed while the electronic device is being charged. The database manager 222 may be executed while a display (e.g., the display 110 of FIG. 1 and/or FIG. 2) is deactivated (or in an always-on-display (AOD) mode). As described above, the database manager 222 may be executed to reduce a probability that an activity of the user associated with the electronic device is interrupted or delayed by the resource occupied by the database manager 222.

Referring to FIG. 3, functions supported by the database manager 222 are illustrated by being divided into different blocks. The database manager 222 may store feature information of handwriting objects included in the note contents and/or information indicating a category associated with the note contents, to be used for searching of the note contents, in each of a feature DB 232 and a category DB 236. The feature information may indicate a figure and/or a shape represented by the handwriting objects.

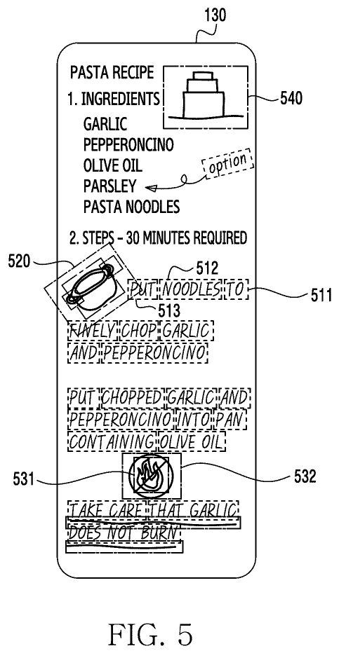

Referring to FIG. 3, the database manager 222 may include a handwriting group extractor 310 for extracting a handwriting object included in a note content. A processor that has executed the handwriting group extractor 310 may classify elements included in the note content into text and the handwriting object. The handwriting object may include a plurality of strokes included in the note contents. The processor may classify the plurality of strokes into a text-stroke representing handwriting including one or more characters, and a non-text stroke different from the text-stroke. An operation of the processor for classifying the elements included in the note content based on the handwriting group extractor 310 will be described with reference to FIG. 5.

In an embodiment, the processor identifying the plurality of text-strokes may divide the plurality of text-strokes into a unit of a line and/or a word. The division may include an operation of grouping the plurality of text-strokes in a unit of a line and/or a word. The processor identifying the plurality of non-text strokes may group the plurality of non-text strokes. The grouping the plurality of non-text strokes may include an operation of grouping the plurality of non-text strokes in a unit of a shape represented by the plurality of non-text strokes. For example, the processor may group or cluster the plurality of non-text strokes that are disposed adjacent to each other or connected to each other.

Referring to FIG. 3, the database manager 222 may include a feature information extractor 320 for determining feature information of the handwriting objects extracted by the handwriting group extractor 310. The feature information extracted by the feature information extractor 320 may correspond to at least one of the handwriting objects extracted by the handwriting group extractor 310. The feature information may include data indicating a shape and/or a time (e.g., a timing when a stroke is drawn) of at least one stroke corresponding to the feature information. The feature information may include at least one of coordinate values of one or more points included in the stroke, a direction of the stroke (e.g., a proceeding direction of the stroke), and/or an angle of the stroke (e.g., a proceeding angle of the stroke).

Referring to FIG. 3, the database manager 222 may include a keyword extractor 330 for obtaining information related to one or more characters from the handwriting objects extracted by the handwriting group extractor 310. The keyword extractor 330 may determine at least one word (hereinafter, a keyword) associated with the handwriting objects. The keyword extractor 330 may include a character recognizer 332 for recognizing characters represented by the handwriting objects and/or a combination (e.g., a word and/or a sentence) of the characters. The character recognizer 332 may recognize at least one character represented by the handwriting objects based on an optical character recognition (OCR) and/or an artificial neural network. The keyword extractor 330 may include a shape recognizer 334 for determining at least one word describing a shape of the handwriting objects.

For example, feature information (e.g., feature information determined based on execution of the feature information extractor 320) and text (e.g., text recognized by the character recognizer 332) included in the handwriting may be extracted from a handwriting object. For example, in a case that the handwriting object includes at least one figure, the feature information (e.g., the feature information determined based on the execution of the feature information extractor 320) and a name (e.g., a name recognized by the shape recognizer 334) of the at least one figure may be extracted from the handwriting object. In the above example, in a case that the name associated with the at least one figure is not determined based on the execution of the shape recognizer 334, only the feature information (e.g., the feature information determined based on the execution of the feature information extractor 320) may be extracted from the handwriting object. As described above, based on the execution of the keyword extractor 330, a keyword associated with the handwriting object may be determined from the handwriting object.

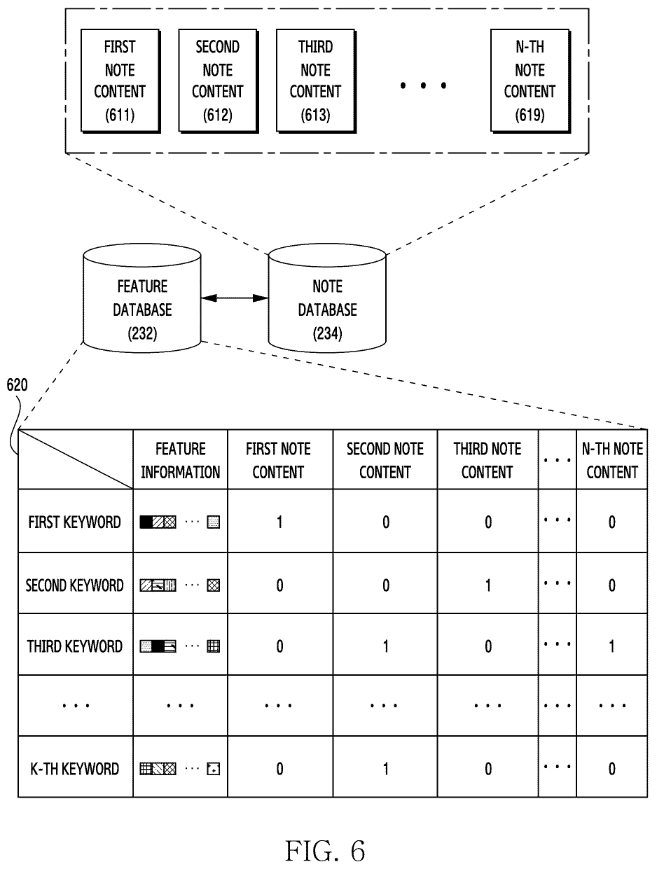

Referring to FIG. 3, the database manager 222 may include a feature DB manager 340 for indexing the handwriting object, using the feature information and the keyword corresponding to the handwriting object, determined by each of the feature information extractor 320 and the keyword extractor 330. The processor that has executed the feature DB manager 340 may store a combination (e.g., a record) of the handwriting object, the feature information, and the keyword extracted from the note content in the feature DB 232. The feature information stored in the feature DB 232, which is an arrangement of data representing the handwriting object (e.g., a group of one or more strokes), may include, for example, at least one of a tensor, an arrangement of coordinate values included in a stroke, and/or a direction vector of the stroke. An operation of the processor that has executed the feature DB manager 340 to update the feature DB 232 will be described in greater detail below with reference to FIG. 6.

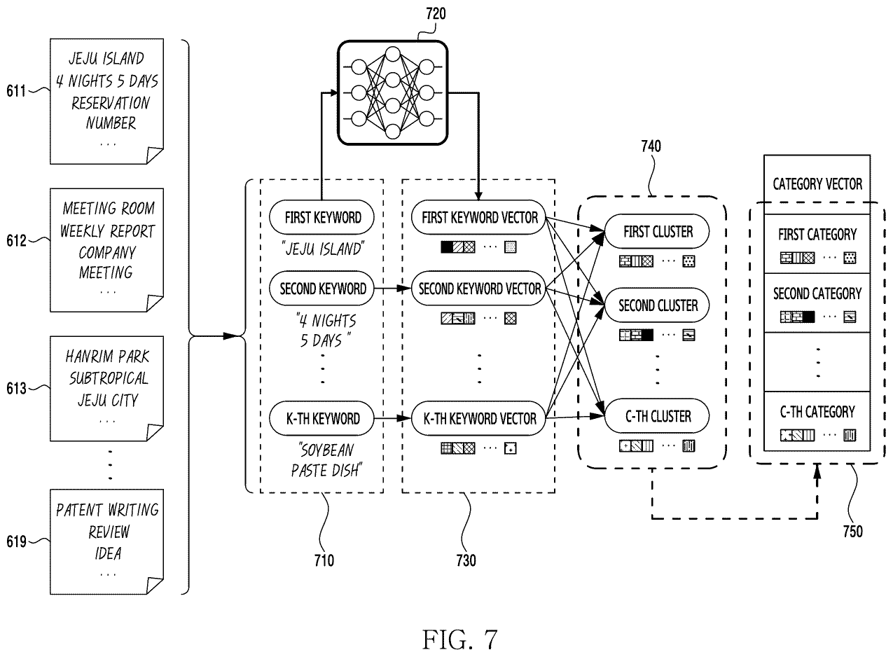

Referring to FIG. 3, the database manager 222 may include a category DB manager 350 for clustering the note content including the handwriting object using at least one keyword corresponding to the handwriting object determined by the keyword extractor 330. A result of clustering the note content based on execution of the category DB manager 350 may be stored in the category DB 236. The processor that has executed the category DB manager 350 may determine a plurality of categories using keywords extracted from all note contents stored in the memory. The processor may generate information (e.g., a category vector) indicating a relationship between each of the plurality of categories and the note contents. The information may include numerical values indicating a degree of relevance of each of the plurality of categories with respect to a specific note content. The processor may store, in the category DB 236, degrees of relevance of the plurality of categories and the plurality of note contents. An operation of the processor executing the category DB manager 350 to update the category DB 236 will be described with reference to FIGS. 7 and/or 8.

Referring to FIG. 3, the processor executing the keyword extractor 330 and/or the category DB manager 350 may determine one or more words (e.g., a keyword) associated with the note content using a language model 360. The language model 360 may include a recognition model implemented with software or hardware (e.g., a neural processing unit (NPU) and/or a GPU) that mimics computational power of a biological system using a large number of artificial neurons (or nodes). Based on driving of the language model 360, the processor may simulate a human cognitive action, a learning process, and/or a creation process through the artificial neurons. As information associated with the language model 360, numerical values (e.g., weights) indicating an association between nodes (e.g., perceptrons) included in the language model 360 may be stored in the memory of the electronic device.

In an embodiment, the language model 360 may include a generative model having a structure based on a transformer such as a bidirectional encoder representations from transformers (BERT) and/or a generative pre-trained transformer (GPT). The disclosure is not limited thereto, and the language model 360 may have a structure based on a recurrent neural network (RNN), a convolutional neural network (CNN), a long-short term memory (LSTM), and/or a feedforward network (FFN). The language model 360 may be implemented as a combination of software and/or hardware included in the electronic device. The disclosure is not limited thereto, and the language model 360 may be included in an external electronic device connected to the electronic device through a network.

As described above, in order to index a handwriting object included in a note content, the electronic device according to an embodiment may determine feature information of the handwriting object and/or one or more keywords associated with the handwriting object. Using the feature DB 232 where the feature information is stored, the processor may accurately perform a search based on the handwriting object even when a keyword corresponding to the handwriting object is incorrectly determined. Using the feature DB 232, the processor may perform a search of the note content based on a shape and/or the handwriting object from the user. For example, using the feature DB 232 and/or the category DB 236 including semantic information extracted from the handwriting object, the processor may support the search of the note content.

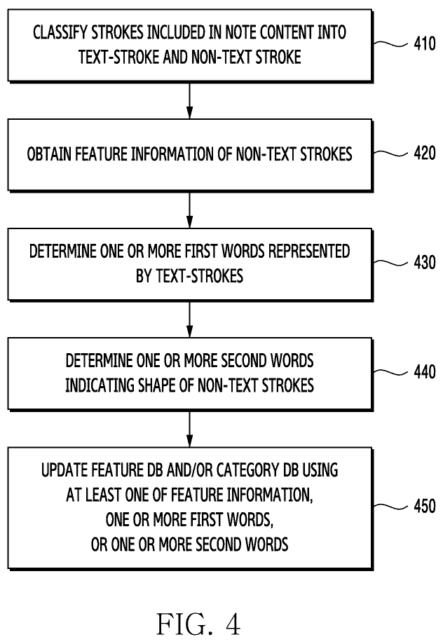

Hereinafter, with reference to FIG. 4, an operation of the electronic device described with reference to FIG. 3 will be described in greater detail.

FIG. 4 is a flowchart illustrating an example operation of an electronic device according to various embodiments. The operation of the electronic device described with reference to FIG. 4 may be performed by the electronic device 101 of FIGS. 1 and 2 and/or the processor 210 of FIG. 2. The operation of the electronic device described with reference to FIG. 4 may be performed based on execution of the database manager 222 of FIG. 2.

Referring to FIG. 4, in operation 410, a processor of the electronic device according to an embodiment may classify strokes included in a note content into a text-stroke and a non-text stroke. Operation 410 of FIG. 4 may include an operation of the handwriting group extractor 310 of FIG. 3. The processor may classify a handwriting object included in the note content, for example, a plurality of strokes, into the text-stroke and the non-text stroke. The processor may perform operation 430 on the text-stroke identified based on operation 410. The processor may perform operation 420 on the non-text stroke identified based on operation 410.

Referring to FIG. 4, in operation 420, the processor of the electronic device according to an embodiment may obtain feature information of non-text strokes. Operation 420 of FIG. 4 may include an operation of the feature information extractor 320 of FIG. 3. The processor may obtain feature information indicating coordinate values and/or an order of points included in the non-text strokes. The processor may obtain feature information indicating a direction and/or an angle of the non-text strokes. The processor may obtain feature information indicating a shape of the non-text strokes. The feature information may include data for displaying the non-text strokes.

Referring to FIG. 4, in operation 430, the processor of the electronic device according to an embodiment may determine one or more first words represented by text-strokes. Operation 430 of FIG. 4 may include an operation of the keyword extractor 330 and/or the character recognizer 332 of FIG. 3. The one or more first words may include a combination of one or more characters recognized from the text-strokes. When the processor groups the text-strokes in a unit of a word, the one or more first words identified based on the operation 430 may correspond to any one group of the text-strokes.

Referring to FIG. 4, in operation 440, the processor of the electronic device according to an embodiment may determine one or more second words indicating a shape of the non-text strokes. Operation 440 of FIG. 4 may include an operation of the keyword extractor 330 and/or the shape recognizer 334 of FIG. 3. The one or more second words may include a name of one or more figures represented by the non-text strokes. The one or more second words may include a word representing a shape described by any one group of the non-text strokes.

Determining the one or more first words and/or the one or more second words of operations 430 and 440 of FIG. 4 may be performed based on a language model (e.g., the language model 360 of FIG. 3). For example, the processor may obtain the one or more first words of operation 430 and/or the one or more second words of operation 440 from a language model to which the text-stroke and/or the non-text stroke is input. In an embodiment in which the language model is driven by an external electronic device different from the processor and/or the electronic device performing the operations of FIG. 4, the processor may obtain the one or more first words of operation 430 and/or the one or more second words of operation 440 by communicating with the external electronic device using communication circuitry.

Referring to FIG. 4, in operation 450, the processor of the electronic device according to an embodiment may update a feature DB and/or a category DB using at least one of the feature information of operation 420, the one or more first words of operation 430, or the one or more second words of operation 440. Operation 450 of FIG. 4 may include the operation of the feature DB manager 340 and/or the operation of the category DB manager 350 of FIG. 3. The feature DB of FIG. 4 may include the feature DB 232 of FIG. 3. The category DB of FIG. 4 may include the category DB 236 of FIG. 3.

Hereinafter, an example operation of updating the feature DB and/or the category DB described with reference to FIG. 4 will be described in greater detail with reference to FIGS. 5 to 8.

FIG. 5 is a diagram illustrating an example operation of an electronic device for identifying elements included in a note content 130 according to various embodiments. The operation of the electronic device described with reference to FIG. 5 may be performed by the electronic device 101 of FIGS. 1 and 2 and/or the processor 210 of FIG. 2. The operation of the electronic device described with reference to FIG. 5 may be performed based on execution of the database manager 222 of FIG. 2 and/or a sub-routine (e.g., a writing group extractor 310) of the database manager 222.

Referring to FIG. 5, in the example note content 130 stored in the electronic device, the electronic device may check or identify at least one of a text or a handwriting object. The text may include one or more characters based on a binary code such as Unicode, for example, “pasta recipe”. The handwriting object identified from the note content 130 may include one or more strokes indicated as being drawn by a stylus pen (e.g., the stylus pen 150 of FIG. 1) and/or a touch input. For example, a user may draw a stroke representing a character and/or a figure using the stylus pen.

The example note content 130 of FIG. 5 may include a text-stroke to represent one or more characters (e.g., handwriting drawn after “order”) and/or a non-text stroke to represent a shape. According to an embodiment, the electronic device may group text-strokes included in the note content 130 in a unit of a word. Referring to FIG. 5, boxes represented in a shape of broken lines may correspond to groups of the text-strokes, respectively. For example, based on the grouping, the text-strokes representing handwriting, such as “put noodles to”, may be grouped into a group 512 corresponding to “noodles”, a group 513 corresponding to “put”, and a group 511 corresponding to “to”. The processor may determine feature information and/or at least one keyword corresponding to each of the groups 511, 512, and 513.

The electronic device according to an embodiment may group non-text strokes included in the note content 130 in a unit of the shape represented by the non-text strokes. For example, the processor may determine a group 520 of non-text strokes having a shape of a pot. The processor may group non-text strokes representing a stack of a plurality of rectangles into a group 540. The processor may determine a group 531 including non-text strokes representing fire and a group 532 including non-text strokes representing a prohibition sign.

As described above, the electronic device 2 according to an embodiment may group a plurality of strokes included in the note content 130 based on a meaning of the strokes. Groups for the plurality of strokes may be used to determine semantic information for the plurality of strokes. The semantic information, which is a database managed by the electronic device, may be stored in a feature DB and/or a category DB.

Hereinafter, an example operation of the electronic device for determining a keyword of a handwriting object as the semantic information will be described in greater detail with reference to FIG. 6.

FIG. 6 is a diagram illustrating an example operation of an electronic device that manages a database (e.g., a feature DB 232) associated with a handwriting object included in note contents (e.g., a first note content 611 to an N-th note content 619) according to various embodiments. The operation of the electronic device described with reference to FIG. 6 may be performed by the electronic device 101 of FIGS. 1 and 2 and/or the processor 210 of FIG. 2. The operation of the electronic device described with reference to FIG. 6 may be performed based on execution of the database manager 222 of FIG. 2 and/or a sub-routine (e.g., a feature DB manager 340) of the database manager 222.

Referring to FIG. 6, the electronic device according to an embodiment may obtain N note contents (e.g., the first note content 611 to the N-th note content 619) stored in the electronic device from a note DB 234. The electronic device may extract handwriting objects included in the N note contents based on execution of the handwriting group extractor 310 of FIG. 3. The electronic device may determine a plurality of keywords associated with the handwriting objects based on execution of a keyword extractor 330. The plurality of keywords may include a word indicated by text-strokes included in a handwriting object. The plurality of keywords may include a word describing a shape indicated by non-text strokes included in the handwriting object.

Referring to FIG. 6, in an embodiment of determining k keywords, the electronic device may determine feature information of each of the k keywords. The feature information may indicate a shape of strokes (e.g., the text-strokes and/or the non-text strokes) corresponding to the k keywords. The electronic device may generate records corresponding to each of the k keywords in the feature DB 232. Referring to FIG. 6, in the feature DB 232, an example table 620 including the records corresponding to each of k keywords is illustrated. The table 620 may be referred to as a keyword-feature table in terms of including a keyword and feature information.

A record in the table 620 of the feature DB 232 may correspond to any one of the k keywords. A relationship between the record and the keyword may be mapped by an identifier (e.g., an index value and/or a unique key) uniquely assigned to the keyword. The record in table 620 may include feature information of a corresponding keyword. The record in the table 620 may be arranged along columns corresponding to each of the N note contents, and may include numerical values (e.g., a flag) indicating whether the keyword corresponding to the record is included in each of the plurality of note contents. For example, a column of the table 620 corresponding to a specific note content may include numerical values indicating whether each of the k keywords corresponding to different records is included in the specific note content.

Referring to FIG. 6, a numerical value assigned to the column of the table 620 corresponding to the specific note content may be determined as “1” when the keyword is included in the specific note content, and “0” when the keyword is not included in the specific note content. Referring to the example table 620 of FIG. 6, the first note content 611 may include a first keyword and may not include a second keyword. The second note content 612 may include a third keyword and may not include the first keyword and the second keyword. The third note content 613 may include only the second keyword among the first keyword to the third keyword. The N-th note content 619 may include the third keyword and may not include the first keyword and the second keyword. A k-th keyword may be included in the second note content 612 among the first note content 611, the second note content 612, and the third note content 613.

As described above, the electronic device according to an embodiment may obtain keywords determined from the plurality of strokes included in the note contents as a handwriting object and a relationship between the note contents. The relationship may be stored in the feature DB 232. In the feature DB 232, the electronic device may store feature information corresponding to the handwriting object used to determine the keyword. For example, the records of the feature DB 232 may correspond to each of groups of one or more strokes, such as the groups 512, 513, 520, 531, 532, and 540 of FIG. 5.

Hereinafter, an example operation of an electronic device for generating and/or managing a category DB will be described in greater detail with reference to FIGS. 7 and/or 8.

FIG. 7 is a diagram illustrating an example operation of an electronic device for clustering note contents (a first note content 611 to an N-th note content 619) using a handwriting object included in the note contents according to various embodiments. The operation of the electronic device described with reference to FIG. 7 may be performed by the electronic device 101 of FIGS. 1 and 2 and/or the processor 210 of FIG. 2. The operation of the electronic device described with reference to FIG. 7 may be performed based on execution of the database manager 222 of FIG. 2 and/or a sub-routine (e.g., a category DB manager 350) of the database manager 222.

Referring to FIG. 7, the electronic device according to an embodiment may extract handwriting objects included in N note contents (e.g., the first note content 611 to the N-th note content 619). The electronic device may determine a plurality of keywords 710 associated with the extracted handwriting objects. The electronic device may obtain keyword vectors 730 corresponding to each of the plurality of keywords 710 using a model for word embedding, such as a large language model (LLM) 720. The disclosure is not limited thereto, and the electronic device may obtain the keyword vectors 730 by performing an algorithm for word embedding, including skip-gram, continuous bag of words (CBOW), and/or global vector representation (glove).

In an embodiment, the k keyword vectors 730 corresponding to each of the k keywords 710 may be distributed based on a relationship between words in a vector space. For example, vectors indicating words having similar meanings may be disposed in adjacent positions within the vector space. In an embodiment identifying the k keyword vectors 730, the processor may cluster the keyword vectors 730 using a positional relationship within the vector space of the keyword vectors 730. Based on the clustering, the processor may obtain c (e.g., c<k) clusters. The clusters may include cluster vectors 740 included in the vector space where the keyword vectors 730 are disposed. The cluster vectors 740 may be a representative value of keyword vectors adjacent to each other within the vector space.

In an embodiment, the number of the clusters may be adaptively adjusted by an update of the note contents within a range less than a designated threshold (e.g., 100). For example, as the number of the note contents increases, the number of the clusters may increase within the range. The electronic device may perform clustering on the k keyword vectors 730 by performing at least one of a K-means clustering algorithm, a K-median value clustering algorithm, an average moving clustering algorithm, a density-based spatial clustering of applications with noise (DBSCAN), and/or an expectation-maximization (EM) clustering algorithm based on gaussian mixture models (GMM).

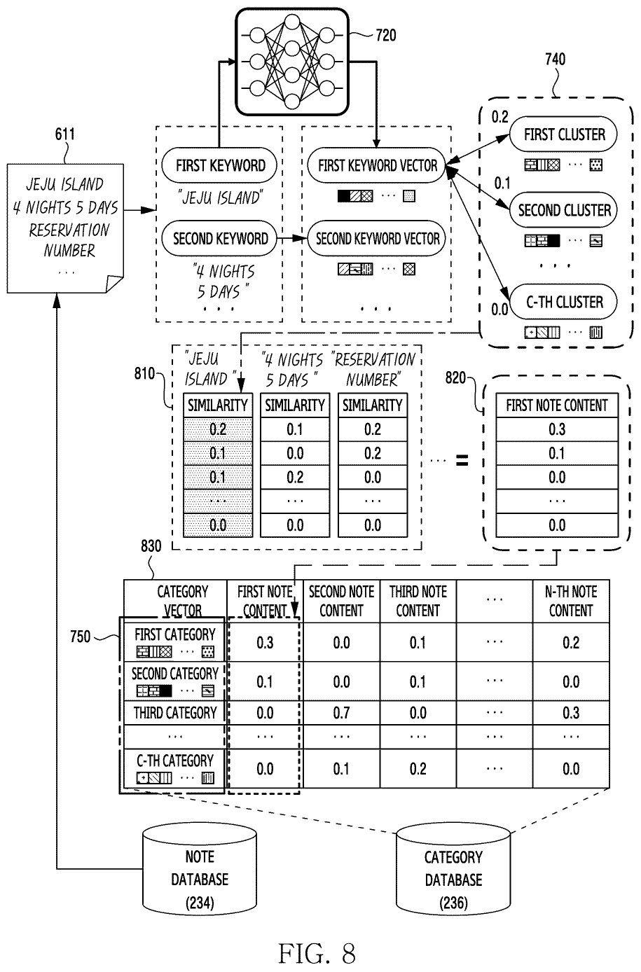

Referring to FIG. 7, in an embodiment of determining the c cluster vectors 740, the processor may determine c categories 750 corresponding to each of the cluster vectors 740. Hereinafter, an example operation of the electronic device that manages a category DB indicating a relationship between the c categories 750 and the note contents will be described in greater detail with reference to FIG. 8.

FIG. 8 is a diagram illustrating an example operation of an electronic device that manages a database (e.g., a category DB 236) associated with note contents based on clustering of the note contents according to various embodiments. The operation of the electronic device described with reference to FIG. 8 may be performed by the electronic device 101 of FIGS. 1 and 2 and/or the processor 210 of FIG. 8. The operation of the electronic device described with reference to FIG. 8 may be performed based on execution of the database manager 222 of FIG. 2 and/or a sub-routine (e.g., a category DB manager 350) of the database manager 222.

Referring to FIG. 8, an example operation of the electronic device for determining a category vector 820 of a first note content 611 among N note contents (e.g., the first note content 611 to the N-th note content 619 of FIGS. 6 to 7) stored in memory of the electronic device according to an embodiment is described. The electronic device may determine category vectors corresponding to remaining N-1 note contents based on the operation of FIG. 8. The first note content 611 may be loaded or identified from a note DB 234.

Referring to FIG. 8, the electronic device may extract handwriting objects (e.g., a plurality of strokes) included in the first note content 611. The electronic device may determine keywords (e.g., “Jeju Island”, “4 nights and 5 days”, and/or “reservation number”) corresponding to the extracted handwriting objects, and may determine keyword vectors corresponding to each of the keywords. As described above with reference to FIG. 7, the electronic device may determine the keyword vectors using a language model such as an LLM 720. In an embodiment of determining the c cluster vectors 740 based on the operation described with reference to FIG. 7, the electronic device may calculate each of similarities between the keyword vectors and the cluster vectors 740. The similarity may be an inner product of vectors.

For example, each of inner products between a first keyword vector corresponding to the first keyword (e.g., “Jeju Island”) and the cluster vectors 740 may be determined as each of similarities between the first keyword vector and the cluster vectors 740. Similarly, the electronic device may determine similarities between another keyword and the cluster vectors 740. Referring to FIG. 8, example similarities 810 between three keyword vectors corresponding to three keywords included in the first note content 611 and the cluster vectors 740 are illustrated. The processor may calculate weighted sums of the similarities 810. The processor may determine the category vector 820 including the weighted sums. Each of elements of the category vector 820 may be a weighted sum of similarities of each of a plurality of keyword vectors for a specific cluster vector. For example, the weighted sum may be an overall similarity between a note content and a cluster, based on keyword vectors of the note content. For example, the weighted sum may be a similarity between the note content and the cluster.

The operation of determining the category vector 820 corresponding to the first note content 611 described with reference to FIG. 8 may be similarly performed for other note contents different from the first note content 611. In an embodiment, the electronic device may determine category vectors of a plurality of note contents (e.g., the first note content 611 to the N-th note content 619 of FIGS. 6 to 7) stored in the memory. The category vectors may be stored in the category DB 236.

Referring to FIG. 8, an example table 830 for storing category vectors corresponding to each of the N note contents in the category DB 236 is illustrated. The table 830 may be referred to as a category indexing table in terms of including the category vectors. A record in the table 830 of the category DB 236 may correspond to each of the categories 750 distinguished by the c cluster vectors 740. The record in table 830 may include a cluster vector of a corresponding category. Each of columns of the table 830 may be a category vector of a corresponding note content. For example, each of columns included in a record of a specific category may store a similarity between the specific category and the note content, indicated by category vectors.

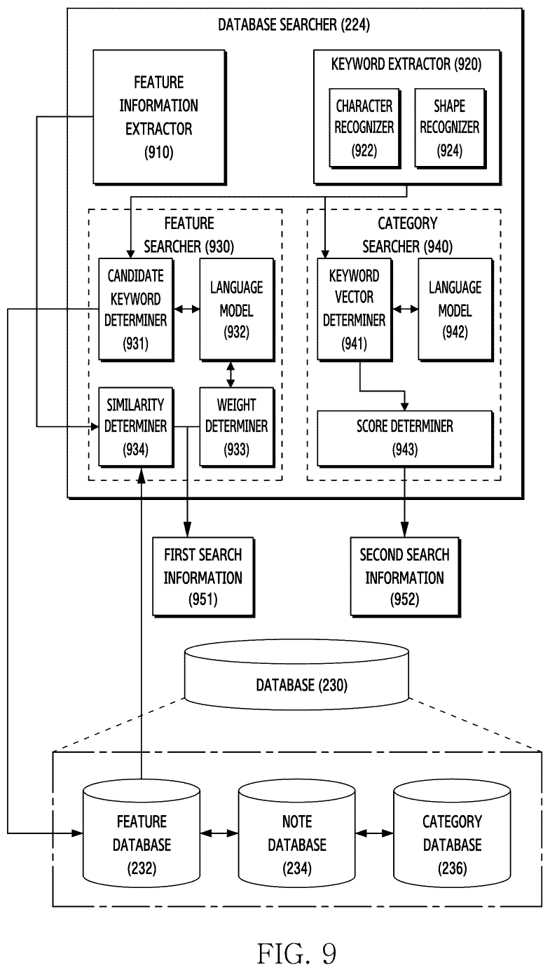

As described above, the electronic device according to an embodiment may generate a feature DB and a category DB from handwriting objects included in a plurality of note contents stored in the electronic device. Based on addition, deletion, and/or change of at least one note content, the electronic device may update the feature DB and/or the category DB. Hereinafter, an example operation of the electronic device that a search for note contents using the updated feature DB and/or category DB based on the operation described with reference to FIGS. 2 to 8 will be described in greater detail with reference to FIGS. 9 to 11.

FIG. 9 is a diagram illustrating an example operation of an electronic device for searching note contents including a handwriting object using a database 230 generated using the handwriting object according to various embodiments. The operation of the electronic device described with reference to FIG. 9 may be performed by the electronic device 101 of FIGS. 1 and 2 and/or the processor 210 of FIG. 2. The operation of the electronic device described with reference to FIG. 9 may be performed based on execution of the database searcher 224 of FIG. 2.

The electronic device according to an embodiment may display a UI for searching for note contents, such as a screen displayed on the display 110 of FIG. 1. In response to a user input received through the UI, the electronic device may execute a function for searching the note contents by executing the database searcher 224. Although an embodiment of receiving a user input through a visualized UI such as the screen of FIG. 1 is described, the disclosure is not limited thereto. For example, the electronic device may receive a user input including a speech, such as a voice command.

Referring to FIG. 9, functions supported by the database searcher 224 are illustrated by being divided into different blocks. The database searcher 224 may obtain information (e.g., feature information and/or a keyword) to be used to access the database 230 from a handwriting object included in the user input for searching the note contents, similar to generating the database 230 (e.g., a feature DB 232 and/or a category DB 236) for a search of handwriting objects included in the note contents.

Referring to FIG. 9, the database searcher 224 may include a feature information extractor 910 for determining feature information of the handwriting objects (e.g., one or more strokes) included in the user input. An operation of the processor that has executed the feature information extractor 910 of FIG. 9 may be substantially similar to the operation of the processor has executed the feature information extractor 320 of FIG. 3. For example, the electronic device that has detected a plurality of strokes based on an external object, such as the stylus pen 150 of FIG. 1, may determine feature information for the plurality of strokes based on the execution of the feature information extractor 910. The feature information may include coordinate values of points included in each of the plurality of strokes, timings when the points are detected, an order of the points, directions of each of the plurality of strokes, and/or angles of each of the plurality of strokes.

Referring to FIG. 9, the database searcher 224 may include a keyword extractor 920 for determining a keyword corresponding to the handwriting objects included in the user input. An operation of the processor that has executed the keyword extractor 920 of FIG. 9 may be substantially similar to the operation of the processor has executed the keyword extractor 330 of FIG. 3. The keyword extractor 920 of FIG. 9 may include a character recognizer 922 for recognizing one or more characters represented by the handwriting objects. The keyword extractor 920 of FIG. 9 may include a shape recognizer 924 for determining at least one word describing a shape of the handwriting objects. The character recognizer 922 and/or the shape recognizer 924 may correspond to the character recognizer 332 and/or the shape recognizer 334 of FIG. 3.

In an embodiment, the processor that has executed the keyword extractor 920 may identify at least one keyword corresponding to the handwriting objects included in the user input. The processor identifying the at least one keyword may calculate reliability of the at least one keyword with respect to the handwriting objects. In an embodiment, based on whether reliability of a keyword identified by the keyword extractor 920 exceeds a designated threshold, the processor may determine whether to use the keyword for the search of the note contents. For example, the processor that has identified a keyword having reliability less than or equal to the designated threshold may not use the keyword for the search of the note contents (e.g., bypass and/or discard). For example, the processor that has identified a keyword having reliability exceeding the designated threshold may use the keyword for the search of the note contents. In the example, the keyword having the reliability exceeding the designated threshold may be used for execution of a feature searcher 930 and/or a category searcher 940.

As described above, the electronic device that has received the user input for the search of the note contents may distinguish or separate a text and/or a handwriting object from the user input. The processor that has identified text-strokes from the handwriting object may determine at least one keyword corresponding to the text-strokes by performing character recognition based on the character recognizer 922. The processor that has identified non-text strokes from the handwriting object may obtain at least one keyword describing a shape of the non-text strokes based on the execution of the shape recognizer 924. The at least one keyword obtained based on the execution of the keyword extractor 920 may be used for the search of the note contents based on at least one reliability corresponding to the at least one keyword.

In an embodiment, the electronic device that received the user input for the search of the note contents may obtain feature information (e.g., the feature information obtained based on the execution of the feature information extractor 910) and at least one keyword (e.g., the keyword obtained based on the execution of the keyword extractor 920). In an embodiment, the electronic device may search note contents similar to handwriting included in the user input using the feature information. The electronic device may search note contents associated with a category similar to the user input using the at least one keyword. Since no keyword may be used for the search of the note contents according to reliability, the electronic device may search the note content using only the feature information.

Referring to FIG. 9, the database searcher 224 may include the feature searcher 930 for the search of the note contents based on feature information. For example, the electronic device that has executed the feature searcher 930 may search note contents having feature information similar to the feature information of the plurality of strokes included in the user input. Referring to FIG. 9, the feature searcher 930 may include a candidate keyword determiner 931 for determining one or more keywords similar to the at least one keyword, obtained by the keyword extractor 920, associated with the user input. The electronic device that has executed the candidate keyword determiner 931 may determine a candidate keyword similar to the at least one keyword by searching a language model 932 using the at least one keyword determined by the keyword extractor 920. The language model 932 may include information for indicating a relationship between words, such as a dictionary and/or CBOW. In the language model 932, words frequently recognized by crossing from the handwriting object due to misrecognition may be linked to each other.

Referring to FIG. 9, the feature searcher 930 may include a weight determiner 933 for determining a weight corresponding to at least one candidate keyword determined by the candidate keyword determiner 931. For example, based on the search of the language model 932, the electronic device may detect or determine a similarity (or a degree of relevance) between the at least one keyword and the candidate keyword. The similarity may be determined as a weight for the candidate keyword. The similarity between two words may indicate a similarity of characters included in the words. The similarity between two words may indicate a probability that the handwriting representing a first word among the words is recognized as a second word among the words due to misrecognition.

Referring to FIG. 9, the feature searcher 930 may calculate or determine each of similarities of the candidate keywords by comparing information of the feature DB 232 corresponding to the candidate keywords determined by the candidate keyword determiner 931 and feature information determined by the feature information extractor 910. In order to calculate the similarity between the feature information, an algorithm such as dynamic time warping (DTW) may be used. For example, an algorithm for calculating a similarity of vectors with different sizes (or lengths) may be used.

Referring to FIG. 9, the electronic device that has executed the feature searcher 930 may extract at least one keyword having feature information similar to the user input from among keywords stored in the feature DB 232 using similarities determined by a similarity determiner 934 and weights determined by the weight determiner 933. The electronic device may provide a note content including the extracted at least one keyword as a result of searching the note contents based on the feature information.

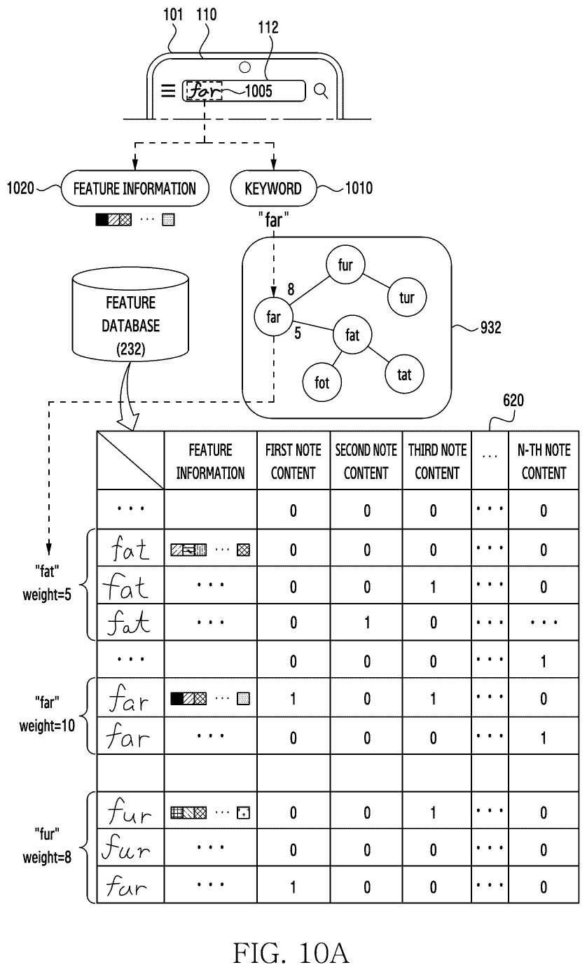

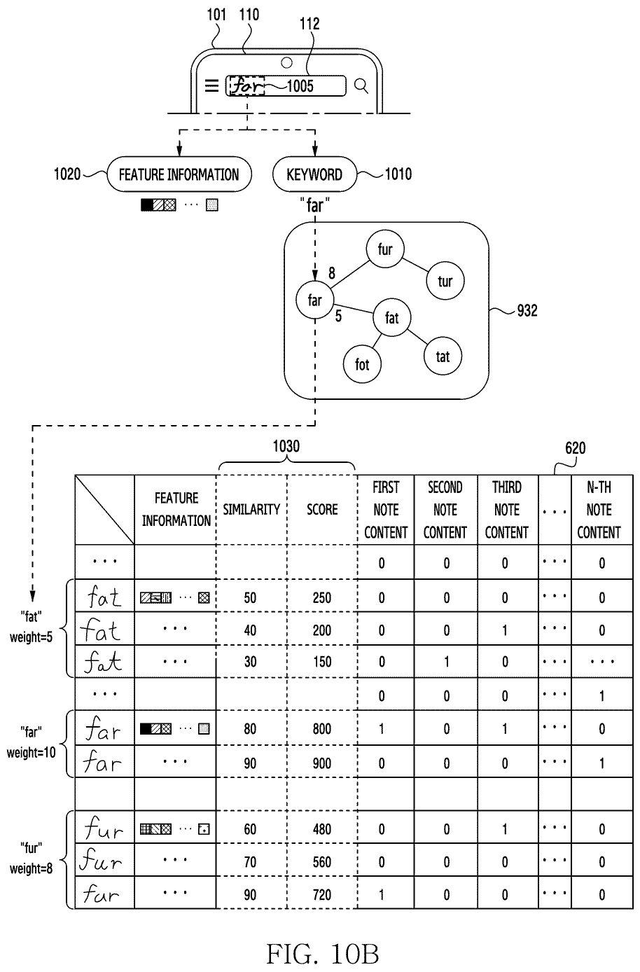

In an embodiment, first search information 951 may include the note content including the extracted at least one keyword. The first search information 951 may include information for selecting or importing the note content including the extracted at least one keyword from the note DB 234. The information may include at least one of an index value of the note content and/or a path name of the note content, such as a uniform resource indicator (URI). An example operation of the electronic device for obtaining the first search information 951 using the feature searcher 930 will be described in greater detail below with reference to FIGS. 10A and/or 10B.

Referring to FIG. 9, the database searcher 224 may include a category searcher 940 for the search of the note contents based on a category. The electronic device that has executed the category searcher 940 may calculate similarities between at least one keyword and a plurality of categories, determined as associated with the user input using the keyword extractor 920. Using the calculated similarities, the electronic device may search note contents included in a category associated with the user input.

Referring to FIG. 9, the category searcher 940 may include a keyword vector determiner 941 for determining at least one keyword vector corresponding to the at least one keyword obtained by the keyword extractor 920. Similar to the description described with reference to FIGS. 7 to 8, the keyword vector determiner 941 may determine a keyword vector using a language model 942. The language model 942 may include an LLM (e.g., the LLM 720 of FIG. 7). Using the keyword vector determiner 941, the electronic device may obtain at least one keyword vector associated with the non-text strokes included in the user input.

Referring to FIG. 9, the category searcher 940 may include a score determiner 943 for calculating similarities of each of a plurality of cluster vectors for the at least one keyword vector obtained by the keyword vector determiner 941. The electronic device that has executed the score determiner 943 may calculate a category vector indicating a similarity between a keyword vector (e.g., the keyword vector determined by the keyword vector determiner 941) associated with the user input and the cluster vectors. The category vector may correspond to an inner product of the keyword vector and the cluster vectors. The category vector may include numerical values indicating a category associated with a keyword mapped to the keyword vector among a plurality of categories.

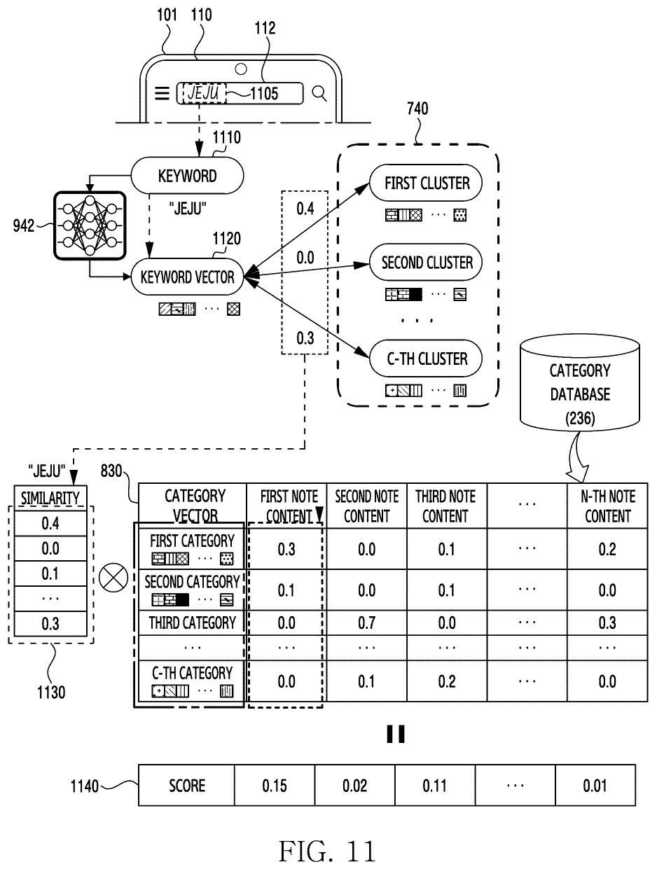

Referring to FIG. 9, the electronic device that has executed the category searcher 940 may determine at least one category associated with the user input in the category DB 236 using the category vector determined by the score determiner 943. The electronic device may obtain at least one note content associated with the user input by searching note contents included in the determined at least one category. Second search information 952 may include the at least one note content searched based on the execution of the category searcher 940. The second search information 952 may include information for selecting or importing the at least one note content from the note DB 234. Similar to the first search information 951, the information may include at least one of an index value of the at least one note content and/or a path name such as URI. An example operation of the electronic device for obtaining the second search information 952 using the category searcher 940 will be described in greater detail below with reference to FIG. 11.

Referring to FIG. 9, the electronic device that has obtained the first search information 951 and/or the second search information 952 may list at least one note content included in the first search information 951 and/or the second search information 952. For example, the electronic device may display a list of the at least one note content on a display (e.g., the display 110 of FIG. 1 and/or FIG. 2). The list may include a link and/or a visual object (e.g., a preview image and/or a thumbnail) for displaying an exclusive screen to the at least one note content.

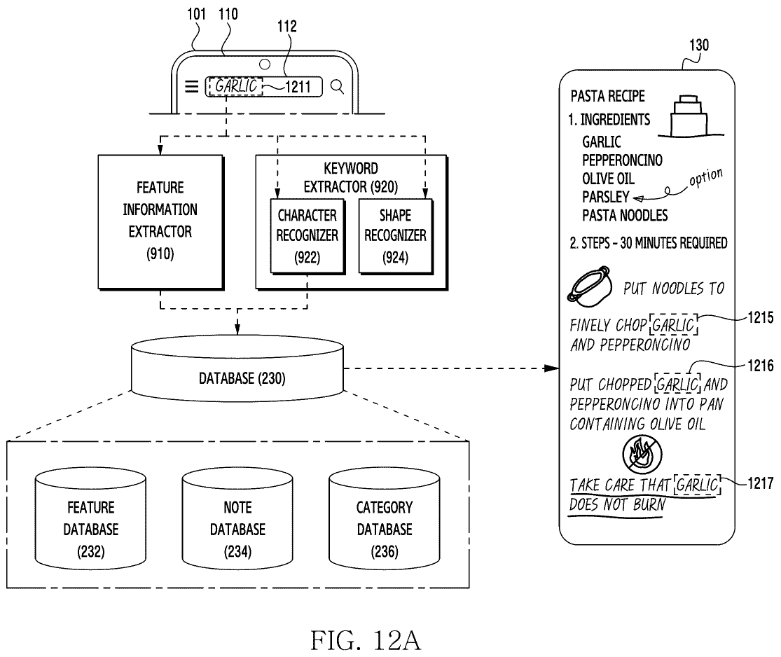

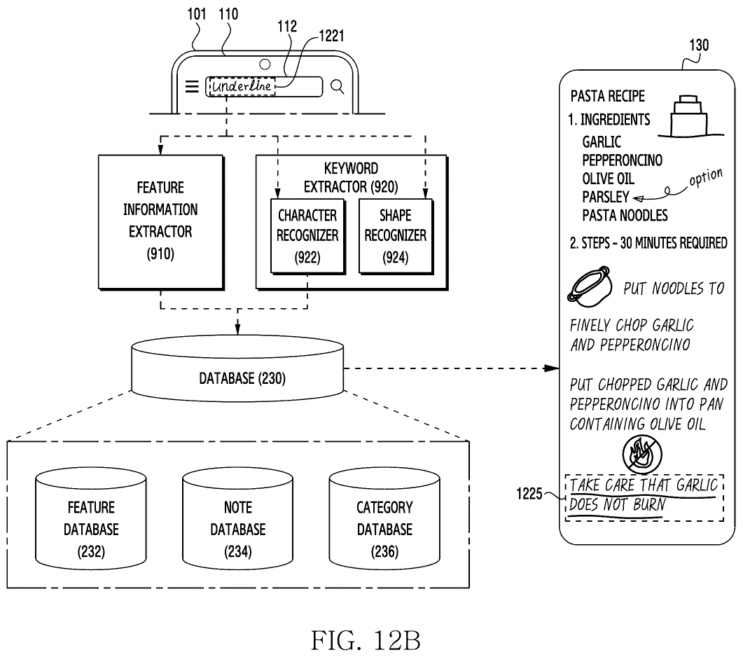

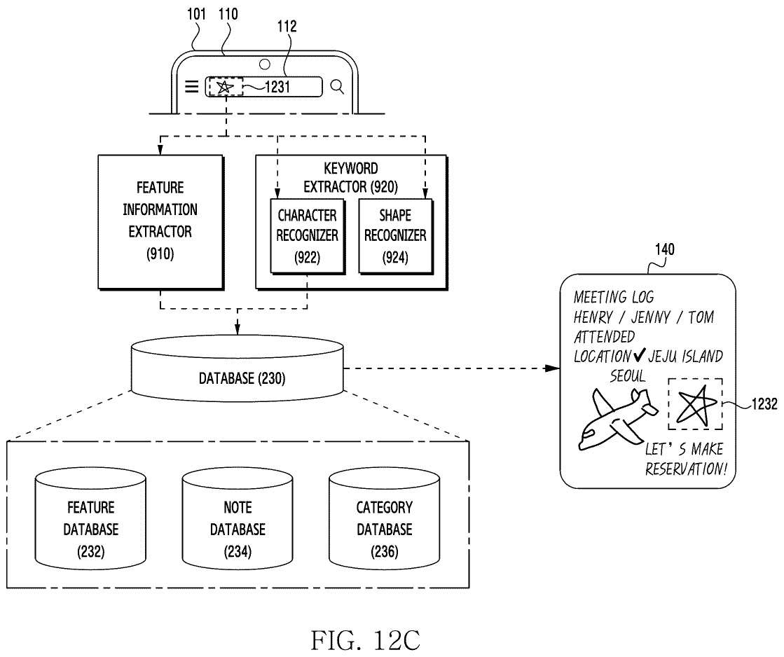

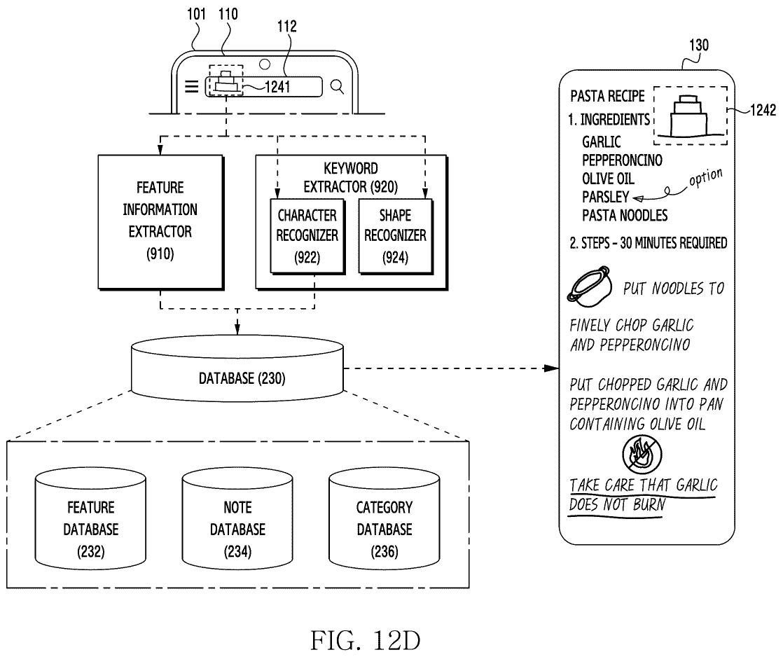

As described above, the electronic device according to an embodiment may identify a first text (e.g., the at least one keyword determined based on the execution of the keyword extractor 920) from the user input for searching the note contents. Based on identifying the first text, the electronic device may determine one or more second texts (e.g., one or more candidate keywords determined based on the execution of the candidate keyword determiner 931) indicated as associated with the first text using the language model 942 representing the relationship between words. The electronic device may determine feature information (e.g., the feature information obtained based on the execution of the feature information extractor 910) of one or more paths based on identifying the one or more paths from the user input. The electronic device may execute a function for searching the database 230 associated with the note contents using at least one of the one or more second texts or the feature information. The electronic device according to an embodiment may display a screen providing the at least one note content on the display in response to at least one note content (e.g., the at least one note content indicated by the first search information 951 and/or the second search information 952) matched to the user input, identified based on the execution of the function. The screen may include the example screen displayed on the display 110 of FIG. 1. An operation of displaying the screen for providing the at least one note content by the electronic device will be described in greater detail below with reference to FIGS. 12A to 12D.

FIGS. 10A and 10B are diagrams illustrating an example operation of an electronic device 101 that performs searching of note contents using one or more strokes indicated by a user input according to various embodiments. The operation of the electronic device 101 described with reference to FIGS. 10A and/or 10B may be performed by the electronic device 101 of FIGS. 1 and 2 and/or the processor 210 of FIG. 2. The operation of the electronic device 101 described with reference to FIGS. 10A and/or 10B may be performed based on execution of the database searcher 224 of FIG. 2.

Referring to FIG. 10A, an example state of the electronic device 101 that has received a user input for searching a plurality of note contents stored in memory (e.g., the memory 215 of FIG. 2) using a first word (e.g., “far”) is illustrated. The user input may include a plurality of strokes received through a region 112. The electronic device 101 that has received the user input including handwriting objects such as the plurality of strokes, may classify the plurality of strokes into either a text-stroke or a non-text stroke. Referring to FIG. 10A, the electronic device 101 that has identified text-strokes representing “far” may group the text-strokes in a unit of word. For example, the electronic device 101 may obtain a group 1005 in which the text-strokes representing “far” are grouped.

Referring to FIG. 10A, the electronic device 101 may obtain feature information 1020 and a keyword 1010 corresponding to the group 1005. The electronic device 101 may obtain the feature information 1020 based on execution of the feature information extractor 910 of FIG. 9. Using the feature information 1020 representing an appearance of one or more characters or a figure represented by the plurality of strokes included in the group 1005, the electronic device 101 may execute a function for searching the note contents.

In an embodiment, the electronic device 101 may obtain the keyword 1010 (e.g., “far”) associated with the plurality of strokes included in the group 1005 based on execution of the keyword extractor 920 of FIG. 9. The electronic device 101 that has identified the group 1005 including text-strokes representing the one or more characters may obtain the keyword 1010 by executing the character recognizer 922 of FIG. 9. The electronic device 101 that has obtained the keyword 1010 may access a language model 932 using the keyword 1010.

Referring to FIG. 10A, a portion of the language model 932 including a node (e.g., a node corresponding to “far”) corresponding to the keyword 1010 is illustrated. Using the language model 932 representing a relationship between words using a numerical value such as a weight, the electronic device 101 may identify one or more candidate keywords having a shape and/or a character similar to the keyword 1010. The electronic device 101 that has searched the language model 932 using the keyword 1010 may identify one or more candidate keywords associated with the keyword 1010 using other nodes connected to the node within the language model 932.

Referring to FIG. 10A, using the example language model 932 in which a node corresponding to the keyword 1010 is connected to a node corresponding to “fat” with a weight of 5, and the node corresponding to the keyword 1010 is connected to a node corresponding to “fur” with a weight of 8, the electronic device 101 may detect “fat” and “fur” as the candidate keyword. A connection between words within the language model 932 may have a weight indicating a similarity and/or relevance between the words. The weight may be a numerical value within a designated range. Referring to FIG. 10A, when each of the candidate keywords “fat” and “fur” is connected to the node corresponding to the keyword 1010 “far” with a weight of 5 and 8, the electronic device 101 may allocate a weight of 10 to the keyword 1010 “far”. The 10 may be a numerical value greater than or equal to the maximum value of the designated range.

Referring to FIG. 10A, in identifying the keyword 1010 (e.g., “far”) from the group 1005 of strokes included in the user input, the electronic device 101 may detect the candidate keywords (e.g., “fat” and “fur”) to which at least one character is replaced among a plurality of characters serially connected within the keyword 1010. In the language model 932, words including similar characters or having a similar shape may be connected to each other with a relatively high weight.

The electronic device 101 according to an embodiment may access a feature DB 232 using the keyword 1010 and the candidate keywords. For example, in a table 620 indicating a relationship between keywords and note contents, included in the feature DB 232, the electronic device 101 may obtain records corresponding to the keyword 1010 and the candidate keywords. Among the candidate keywords, a candidate keyword that does not exist in the feature DB 232 or has feature information different from the feature information stored in the feature DB 232 may be excluded from the candidate keywords. As described above with reference to FIG. 6, each of the records may include feature information of a corresponding keyword and attributes (e.g., relevance and/or similarity) indicating whether the corresponding keyword is included in each of the note contents.

Referring to FIG. 10A, since it searches records including the candidate keywords extracted using the language model 932, the electronic device 101 may obtain even records corresponding to candidate keywords similar to the recognized keyword 1010 from the plurality of strokes included in the user input. For example, when the keyword 1010 corresponding to strokes of the group 1005 differs from intention of a user who drew the strokes, the electronic device 101 may estimate a keyword intended by the user using the candidate keywords similar to the keyword 1010.

Referring to FIG. 10A, an example state is illustrated in the feature DB 232 in which three records corresponding to the candidate keyword “fat”, three records corresponding to the candidate keyword “fur”, and two records corresponding to the keyword 1010 “far” are identified. In the example state of identifying the eight records, the electronic device 101 may calculate similarities between feature information of each of keywords of the eight records and the feature information 1020 determined from user input.

Referring to FIG. 10B, an example state in which the electronic device 101 calculates similarities between the feature information of the keyword 1010 and the candidate keywords and the feature information 1020, identified from the feature DB 232 is illustrated. Referring to FIG. 10B, an example table 1030 including the similarities is illustrated. The table 1030, for convenience of explanation, is identified from the feature DB 232 and is illustrated by overlapping eight records corresponding to the keyword 1010 and/or the candidate keywords.

Referring to the example table 1030 of FIG. 10B, similarities of each of feature information of the eight records with respect to the feature information 1020 may be calculated. The similarities may be calculated based on an algorithm for calculating a similarity, such as an inner product of vectors. The electronic device 101 may calculate scores in the table 1030 by multiplying weights assigned to each of the keyword 1010 and the candidate keywords by the similarity. Each of the scores may be associated with both a similarity (e.g., weight) between a keyword of a corresponding record and the keyword 1010 recognized from the user input, and a similarity between feature information. For example, multiplications of 10, which is a weight of the keyword 1010 “far”, and similarities may be determined as scores of records of the feature DB 232 corresponding to the keyword 1010 “far”. For example, multiplications of 5, which is a weight of the candidate keyword “fat”, and similarities may be determined as scores of records of the feature DB 232 corresponding to the candidate keyword “fat”. For example, multiplications of 8, which is a weight of the candidate keyword “fur”, and similarities may be determined as scores of records of the feature DB 232 corresponding to the candidate keyword “fur”.

Referring to FIG. 10B, the electronic device 101 may determine at least one record having a relatively high similarity and a note content connected to the at least one record as a result of searching the note contents using the scores included in the table 1030. For example, keywords corresponding to five relatively high-scoring records (e.g., records corresponding to each of scores of 900, 800, 720, 560, and 480) and/or note contents including the keywords may be provided as a result of searching the note contents. For example, based on a column including a designated numerical value (e.g., 1) indicating that a keyword corresponding to the record is included from a record having a score of 900, the electronic device 101 may provide or display an N-th note content as a result of the user input.

As described above, even when the keyword 1010 corresponding to the strokes representing handwriting is different from the intention of the user, the electronic device 101 may search the feature DB 232 using the candidate keywords similar to the keyword 1010. Even when the keyword 1010 is different from the intention of the user, the electronic device 101 may increase a probability that a keyword matching the intention of the user is used for searching using the candidate keywords. The electronic device 101 may execute a function for searching for a note content including at least one of the keyword 1010 and the candidate keywords as a text and/or a handwriting object.

Hereinafter, an example operation of the electronic device 101 searching note contents based on a similarity (e.g., a category vector) between the note contents and categories will be described in greater detail with reference to FIG. 11.

FIG. 11 is a diagram illustrating an example operation of an electronic device 101 that performs searching of note contents using feature information of one or more strokes indicated by a user input according to various embodiments. The operation of the electronic device 101 described with reference to FIG. 11 may be performed by the electronic device 101 of FIGS. 1 and 2 and/or the processor 210 of FIG. 2. The operation of the electronic device 101 described with reference to FIG. 11 may be performed based on execution of the database searcher 224 of FIG. 2.

Referring to FIG. 11, an example state of the electronic device 101 that has identified a group 1105 of text-strokes representing “Jeju” is illustrated. The group 1105 may be determined by grouping the text-strokes in a unit of a word. From the group 1105, the electronic device 101 may obtain a keyword 1110 and a keyword vector 1120. In order to obtain the keyword vector 1120, a language model 942 may be used. The electronic device 101 according to an embodiment may compare a feature vector (e.g., the keyword vector 1120) of strokes included in the group 1105 and cluster vectors 740 of each of categories. Based on the comparison, the electronic device 101 may determine similarities between the keyword 1110 represented by the group 1105 and each of the categories. For example, inner products of the keyword vector 1120 for each of the c cluster vectors 740 may be determined as similarities of the keyword vector 1120 for each of the cluster vectors 740.

Referring to FIG. 11, the electronic device 101 may obtain a category vector 1130 including the similarities of the keyword vector 1120 and the cluster vectors 740 as elements. The category vector 1130 corresponding to the keyword vector 1120 may include a numerical value indicating a degree to which each of the cluster vectors 740 is similar to the keyword vector 1120. Referring to example elements of the category vector 1130, a similarity (e.g., 0.4) between a first cluster vector among the cluster vectors 740 and the keyword vector 1120 may be greater than other similarities.

The electronic device 101 according to an embodiment may identify at least one note content associated with the keyword 1110 by comparing the keyword 1110 and/or the category vector 1130 corresponding to the keyword vector 1120 with a plurality of category vectors, stored in a table 830 of a category DB 236 and respectively corresponding to the note contents. The table 830 may include levels at which the note contents are associated with each of a plurality of categories. The electronic device 101 may determine a score vector 1140 indicating a similarity (or relevance) of the note contents for the keyword 1110 using the category vector 1130 and an inner product between category vectors in the table 830. For example, an operation in which the electronic device 101 compares the category vector 1130 and the plurality of category vectors stored in the table 830 may include identifying a relationship between the keyword 1110 and the note contents corresponding to the category vector 1130, using a similarity algorithm such as each of inner products, Euclidean distances, and/or Jaccard similarity. Each of elements of the score vector 1140 may include an inner product of a category vector of a corresponding note content and the category vector 1130. For example, elements (e.g., scores) included in the score vector 1140 may be determined based on the similarities included in the category vector 1130 and the levels stored in the table 830.

Referring to the example score vector 1140 of FIG. 11, a first note content and a third note content having relatively high scores may be determined as note contents associated with the keyword 1110. The electronic device 101 may provide the first note content and the third note content as a result of searching the note contents matched with the user input. When no note content has a score exceeding a designated threshold, the electronic device 101 may determine that the note contents have not been searched using the category DB 236.

As described above, the electronic device 101 according to an embodiment may perform a function for searching the note contents by accessing the category DB 236 based on categories, determined by clustering the note contents, using a text and a handwriting object included in each of the note contents. The electronic device 101 may display a screen providing the at least one note content identified based on the execution of the function on a display (e.g., the display 110 of FIG. 1 and/or FIG. 2).

Hereinafter, example operations of the electronic device 101 that has received each of example user inputs are illustrated in greater detail with reference to FIGS. 12A to 12D.

FIGS. 12A, 12B, 12C, and 12D are diagrams illustrating example operations of an electronic device 101 that has received each of example user inputs according to various embodiments. The operation of the electronic device 101 described with reference to FIGS. 12A to 12D may be performed by the electronic device 101 of FIGS. 1 and 2 and/or the processor 210 of FIG. 2. The operation of the electronic device 101 described with reference to FIGS. 12A to 12D may be performed based on execution of the database searcher 224 of FIG. 2.

As described above with reference to FIGS. 1 to 11, the electronic device 101 according to an embodiment may execute a function for searching the note contents using feature information of handwriting objects including one or more strokes and/or a category determined based on the handwriting objects. The electronic device 101 may support a search of the note contents based on various types of user inputs by executing the function.

Referring to FIG. 12A, an example state of the electronic device 101 that has received a user input including text-strokes representing handwriting (e.g., “garlic”) is illustrated. In the state of FIG. 12A, the electronic device 101 may determine, from a group 1211 of the text-strokes, a keyword (e.g., “garlic”) corresponding to a word represented by the text-strokes. The electronic device 101 may obtain, from the group 1211, feature information determined based on a feature information extractor 910. The electronic device 101 may determine the keyword based on execution of a character recognizer 922 of a keyword extractor 920.

Referring to FIG. 12A, in an example state of determining feature information and the keyword of handwriting objects such as the group 1211 of the text-strokes, the electronic device 101 may access a feature DB 232 using the feature information. The electronic device 101 may search, from the feature DB 232, one or more note contents having a typeface and a shape similar to the word “garlic” indicated by the group 1211, or a similar word (e.g., a word in which one or more characters are different such as “gallic”). For example, the electronic device 101 may detect a note content 130 including groups 1215, 1216, and 1217 of the text-strokes representing “garlic”.

For example, in an example state of FIG. 12A in which the note content 130 is detected, the electronic device 101 may display a text, an icon, and/or a combination thereof representing the note content 130 on a display 110. When detecting a plurality of note contents including the note content 130, the electronic device 101 may display a list of the plurality of note contents on the display 110. The disclosure is not limited thereto, and the electronic device 101 may display only the note content 130 on the display 110.

Referring to FIG. 12B, an example state of the electronic device 101 that has received a user input including text-strokes representing handwriting (e.g., “underline”) is illustrated. In the state of FIG. 12B, the electronic device 101 may determine, from a group 1221 of the text-strokes, a word represented by the text-strokes and a keyword (e.g., “underline”) corresponding to the word. The electronic device 101 may obtain, from the group 1221, the keyword determined based on execution of the character recognizer 922 and feature information determined based on execution of the feature information extractor 910.

Referring to FIG. 12B, the electronic device 101 may search a note content associated with the keyword in the feature DB 232 using the keyword obtained from the group 1221 of the text-strokes. For example, the electronic device 101 may provide the note content 130 including a group 1225 of strokes having a shape of the keyword as a result of searching the note contents. For example, the electronic device 101 may search the note content 130 including strokes having a shape of the underline in response to receiving handwriting for “underline”.

Referring to FIG. 12C, an example state of the electronic device 101 the has received a user input including non-text strokes representing a pentagram is illustrated. In the state of FIG. 12C, the electronic device 101 may obtain feature information of the non-text strokes using the feature information extractor 910 executed based on a group 1231 of the non-text strokes. The electronic device 101 may determine a keyword (e.g., “pentagram”) describing a shape of the group 1231 using the keyword extractor 920 and/or a shape recognizer 924 executed based on the group 1231. The electronic device 101 may execute a function for searching the note contents by accessing a database 230 using the feature information and/or the keyword.

Referring to FIG. 12C, the electronic device 101 may search note contents including a figure described by the keyword in the feature DB 232 using the keyword obtained from the group 1231 of the non-text strokes. For example, the electronic device 101 may provide a note content 140 including a group 1232 of strokes having a shape of the pentagram as a result of searching the note contents. For example, in response to receiving a hand-picture having a shape of the pentagram, electronic device 101 may provide or display the result, including the note content 140 that includes the strokes having a shape of the pentagram.

Referring to FIG. 12D, an example state of the electronic device 101 that has received a user input including non-text strokes representing rectangles stacked along a vertical direction is illustrated. In the state of FIG. 12D, the electronic device 101 may obtain feature information associated with a shape of a group 1241 using the feature information extractor 910 executed based on the group 1241 of the non-text strokes. Referring to FIG. 12D, based on execution of the keyword extractor 920, in a case of obtaining a keyword having reliability less than a designated threshold, the electronic device 101 may not use the keyword obtained using the keyword extractor 920 to the search of the note contents. In the case, the electronic device 101 may access the database 230 (e.g., the feature DB 232) using only feature information.

Referring to FIG. 12D, the electronic device 101 may execute a function for searching note contents associated with a user input using a similarity between feature information corresponding to the user input and feature information stored in the feature DB 232. For example, the electronic device 101 may identify the note content 130 including a figure (e.g., the figure indicated by the group 1242 of the strokes) similar to the figure described by the group 1241. The electronic device 101 that has identified the note content 130 may provide the note content 130 or may display at least a portion of the note content 130, as a result of executing the function.

As described above, the electronic device 101 according to an embodiment may support the search of the note contents based on a handwriting object as well as a text based on a virtual keyboard. The search of the note contents based on the handwriting object may be performed using at least one of feature information of the handwriting object, a keyword associated with the handwriting object, and/or candidate keywords similar to the keyword. For a search robust to misidentification of the handwriting object, the electronic device 101 may perform an operation of indexing the note contents using handwriting objects included in the note contents.

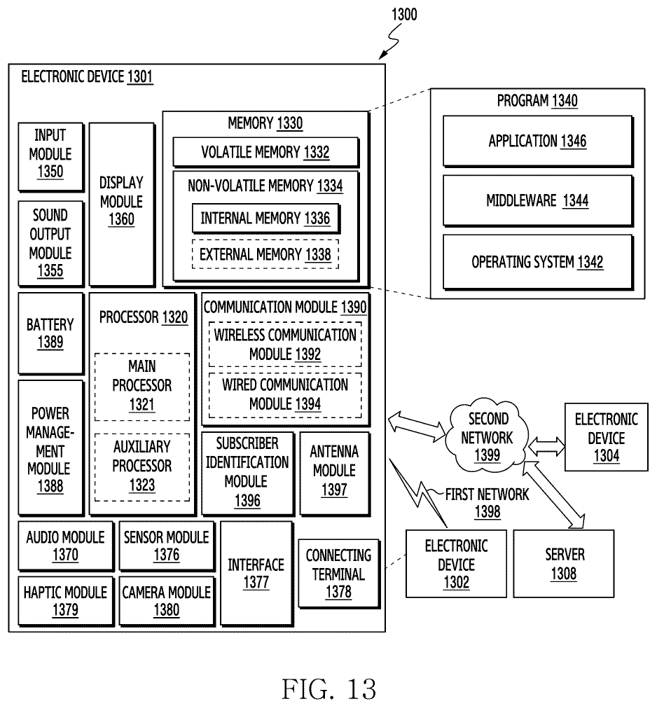

FIG. 13 is a block diagram illustrating an example electronic device 1301 in a network environment 1300 according to various embodiments. Referring to FIG. 13, the electronic device 1301 in the network environment 1300 may communicate with an electronic device 1302 via a first network 1398 (e.g., a short-range wireless communication network), or at least one of an electronic device 1304 or a server 1308 via a second network 1399 (e.g., a long-range wireless communication network). According to an embodiment, the electronic device 1301 may communicate with the electronic device 1304 via the server 1308. According to an embodiment, the electronic device 1301 may include a processor 1320, memory 1330, an input module 1350, a sound output module 1355, a display module 1360, an audio module 1370, a sensor module 1376, an interface 1377, a connecting terminal 1378, a haptic module 1379, a camera module 1380, a power management module 1388, a battery 1389, a communication module 1390, a subscriber identification module (SIM) 1396, or an antenna module 1397. In various embodiments, at least one of the components (e.g., the connecting terminal 1378) may be omitted from the electronic device 1301, or one or more other components may be added in the electronic device 1301. In various embodiments, some of the components (e.g., the sensor module 1376, the camera module 1380, or the antenna module 1397) may be implemented as a single component (e.g., the display module 1360).

The processor 1320 may execute, for example, software (e.g., a program 1340) to control at least one other component (e.g., a hardware or software component) of the electronic device 1301 coupled with the processor 1320, and may perform various data processing or computation. According to an embodiment, as at least part of the data processing or computation, the processor 1320 may store a command or data received from another component (e.g., the sensor module 1376 or the communication module 1390) in volatile memory 1332, process the command or the data stored in the volatile memory 1332, and store resulting data in non-volatile memory 1334. According to an embodiment, the processor 1320 may include a main processor 1321 (e.g., a central processing unit (CPU) or an application processor (AP)), or an auxiliary processor 1323 (e.g., a graphics processing unit (GPU), a neural processing unit (NPU), an image signal processor (ISP), a sensor hub processor, or a communication processor (CP)) that is operable independently from, or in conjunction with, the main processor 1321. For example, when the electronic device 1301 includes the main processor 1321 and the auxiliary processor 1323, the auxiliary processor 1323 may be adapted to consume less power than the main processor 1321, or to be specific to a specified function. The auxiliary processor 1323 may be implemented as separate from, or as part of the main processor 1321. Thus, the processor 1320 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 1323 may control at least some of functions or states related to at least one component (e.g., the display module 1360, the sensor module 1376, or the communication module 1390) among the components of the electronic device 1301, instead of the main processor 1321 while the main processor 1321 is in an inactive (e.g., sleep) state, or together with the main processor 1321 while the main processor 1321 is in an active state (e.g., executing an application). According to an embodiment, the auxiliary processor 1323 (e.g., an image signal processor or a communication processor) may be implemented as part of another component (e.g., the camera module 1380 or the communication module 1390) functionally related to the auxiliary processor 1323. According to an embodiment, the auxiliary processor 1323 (e.g., the neural processing unit) may include a hardware structure specified for artificial intelligence model processing. An artificial intelligence model may be generated by machine learning. Such learning may be performed, e.g., by the electronic device 1301 where the artificial intelligence is performed or via a separate server (e.g., the server 1308). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1330 may store various data used by at least one component (e.g., the processor 1320 or the sensor module 1376) of the electronic device 1301. The various data may include, for example, software (e.g., the program 1340) and input data or output data for a command related thereto. The memory 1330 may include the volatile memory 1332 or the non-volatile memory 1334.

The program 1340 may be stored in the memory 1330 as software, and may include, for example, an operating system (OS) 1342, middleware 1344, or an application 1346.

The input module 1350 may receive a command or data to be used by another component (e.g., the processor 1320) of the electronic device 1301, from the outside (e.g., a user) of the electronic device 1301. The input module 1350 may include, for example, a microphone, a mouse, a keyboard, a key (e.g., a button), or a digital pen (e.g., a stylus pen).

The sound output module 1355 may output sound signals to the outside of the electronic device 1301. The sound output module 1355 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1360 may visually provide information to the outside (e.g., a user) of the electronic device 1301. The display module 1360 may include, for example, a display, a hologram device, or a projector and control circuitry to control a corresponding one of the display, hologram device, and projector. According to an embodiment, the display module 1360 may include a touch sensor adapted to detect a touch, or a pressure sensor adapted to measure the intensity of force incurred by the touch.

The audio module 1370 may convert a sound into an electrical signal and vice versa. According to an embodiment, the audio module 1370 may obtain the sound via the input module 1350, or output the sound via the sound output module 1355 or a headphone of an external electronic device (e.g., an electronic device 1302) directly (e.g., wiredly) or wirelessly coupled with the electronic device 1301.

The sensor module 1376 may detect an operational state (e.g., power or temperature) of the electronic device 1301 or an environmental state (e.g., a state of a user) external to the electronic device 1301, and then generate an electrical signal or data value corresponding to the detected state. According to an embodiment, the sensor module 1376 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1377 may support one or more specified protocols to be used for the electronic device 1301 to be coupled with the external electronic device (e.g., the electronic device 1302) directly (e.g., wiredly) or wirelessly. According to an embodiment, the interface 1377 may include, for example, a high definition multimedia interface (HDMI), a universal serial bus (USB) interface, a secure digital (SD) card interface, or an audio interface.

A connecting terminal 1378 may include a connector via which the electronic device 1301 may be physically connected with the external electronic device (e.g., the electronic device 1302). According to an embodiment, the connecting terminal 1378 may include, for example, an HDMI connector, a USB connector, an SD card connector, or an audio connector (e.g., a headphone connector).

The haptic module 1379 may convert an electrical signal into a mechanical stimulus (e.g., a vibration or a movement) or electrical stimulus which may be recognized by a user via his tactile sensation or kinesthetic sensation. According to an embodiment, the haptic module 1379 may include, for example, a motor, a piezoelectric element, or an electric stimulator.

The camera module 1380 may capture a still image or moving images. According to an embodiment, the camera module 1380 may include one or more lenses, image sensors, image signal processors, or flashes.

The power management module 1388 may manage power supplied to the electronic device 1301. According to an embodiment, the power management module 1388 may be implemented as at least part of, for example, a power management integrated circuit (PMIC).

The battery 1389 may supply power to at least one component of the electronic device 1301. According to an embodiment, the battery 1389 may include, for example, a primary cell which is not rechargeable, a secondary cell which is rechargeable, or a fuel cell.

The communication module 1390 may support establishing a direct (e.g., wired) communication channel or a wireless communication channel between the electronic device 1301 and the external electronic device (e.g., the electronic device 1302, the electronic device 1304, or the server 1308) and performing communication via the established communication channel. The communication module 1390 may include one or more communication processors that are operable independently from the processor 1320 (e.g., the application processor (AP)) and supports a direct (e.g., wired) communication or a wireless communication. According to an embodiment, the communication module 1390 may include a wireless communication module 1392 (e.g., a cellular communication module, a short-range wireless communication module, or a global navigation satellite system (GNSS) communication module) or a wired communication module 1394 (e.g., a local area network (LAN) communication module or a power line communication (PLC) module). A corresponding one of these communication modules may communicate with the external electronic device via the first network 1398 (e.g., a short-range communication network, such as Bluetooth™, wireless-fidelity (Wi-Fi) direct, or infrared data association (IrDA)) or the second network 1399 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1392 may identify and authenticate the electronic device 1301 in a communication network, such as the first network 1398 or the second network 1399, using subscriber information (e.g., international mobile subscriber identity (IMSI)) stored in the subscriber identification module 1396.

The wireless communication module 1392 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1392 may support a high-frequency band (e.g., the mmWave band) to achieve, e.g., a high data transmission rate. The wireless communication module 1392 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1392 may support various requirements specified in the electronic device 1301, an external electronic device (e.g., the electronic device 1304), or a network system (e.g., the second network 1399). According to an embodiment, the wireless communication module 1392 may support a peak data rate (e.g., 20 Gbps or more) for implementing eMBB, loss coverage (e.g., 1364 dB or less) for implementing mMTC, or U-plane latency (e.g., 0.5 ms or less for each of downlink (DL) and uplink (UL), or a round trip of 13 ms or less) for implementing URLLC.

The antenna module 1397 may transmit or receive a signal or power to or from the outside (e.g., the external electronic device) of the electronic device 1301. According to an embodiment, the antenna module 1397 may include an antenna including a radiating element including a conductive material or a conductive pattern formed in or on a substrate (e.g., a printed circuit board (PCB)). According to an embodiment, the antenna module 1397 may include a plurality of antennas (e.g., array antennas). In such a case, at least one antenna appropriate for a communication scheme used in the communication network, such as the first network 1398 or the second network 1399, may be selected, for example, by the communication module 1390 (e.g., the wireless communication module 1392) from the plurality of antennas. The signal or the power may then be transmitted or received between the communication module 1390 and the external electronic device via the selected at least one antenna. According to an embodiment, another component (e.g., a radio frequency integrated circuit (RFIC)) other than the radiating element may be additionally formed as part of the antenna module 1397.

According to various embodiments, the antenna module 1397 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1301 and the external electronic device 1304 via the server 1308 coupled with the second network 1399. Each of the electronic devices 1302 or 1304 may be a device of a same type as, or a different type, from the electronic device 1301. According to an embodiment, all or some of operations to be executed at the electronic device 1301 may be executed at one or more of the external electronic devices 1302, 1304, or 1308. For example, if the electronic device 1301 should perform a function or a service automatically, or in response to a request from a user or another device, the electronic device 1301, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1301. The electronic device 1301 may provide the outcome, with or without further processing of the outcome, as at least part of a reply to the request. To that end, a cloud computing, distributed computing, mobile edge computing (MEC), or client-server computing technology may be used, for example. The electronic device 1301 may provide ultra low-latency services using, e.g., distributed computing or mobile edge computing. In an embodiment, the external electronic device 1304 may include an internet-of-things (IoT) device. The server 1308 may be an intelligent server using machine learning and/or a neural network. According to an embodiment, the external electronic device 1304 or the server 1308 may be included in the second network 1399. The electronic device 1301 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1340) including one or more instructions that are stored in a storage medium (e.g., internal memory 1336 or external memory 1338) that is readable by a machine (e.g., the electronic device 1301). For example, a processor (e.g., the processor 1320) of the machine (e.g., the electronic device 1301) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

In an embodiment, a method of searching a handwriting object in a note content, such as handwriting, may be required. As described above, an electronic device (e.g., the electronic device 101 of FIG. 1) according to an example embodiment may comprise a display (e.g., the display 110 of FIG. 1 and/or FIG. 2), memory (e.g., the memory 215 of FIG. 2), and a processor (e.g., the processor 210 of FIG. 2). The processor may be configured to receive a user input to search note contents stored in the memory. The user input may include at least one of texts input through a virtual keyboard and a path of an external object dragged on the display. The processor may be configured to, based on identifying a first text from the user input, determine one or more second texts indicated as associated with the first text using a language model representing a relationship between words. The processor may be configured to, based on identifying one or more paths from the user input, determine feature information of the one or more paths. The processor may be configured to, using at least one of the one or more second texts or the feature information, execute a function to search a database associated with the note contents. The processor may be configured to, in response to at least one note content matched to the user input which is identified based on execution of the function, display, on the display, a screen providing the at least one note content. The electronic device according to an embodiment may execute the function to search the note content using a text represented by the path of the external object.

For example, the processor may be configured to execute the function using levels where the note contents are associated with each of a plurality of categories, wherein the levels are stored in the database.

For example, the processor may be configured to execute the function by accessing the database based on the categories which are determined by clustering the note contents using a text element and a non-text element included in each of the note contents.

For example, the processor may be configured to determine similarities of each of the categories with respect to a third text by comparing a feature vector corresponding to the third text represented by the one or more paths included in the feature information and cluster vectors (e.g., the cluster vectors 740 of FIG. 7) of each of the categories. The processor may be configured to determine scores of each of the note contents with respect to the third text based on the similarities and the levels. The processor may be configured to identify the at least one note content matched to the user input among the note contents using the scores.

For example, the processor may be configured to execute the function using the feature information indicating an appearance of a character or a figure which is represented by the one or more paths.

For example, the processor may be configured to, by accessing the language model y using the first text, determine the one or more second texts where at least one character among a plurality of characters which are serially connected to each other within the first text.

For example, the processor may be configured to search the at least one note content associated with at least one of the first text or the one or more second texts using the database where similarities of each of the note contes and words recognized from the note contents are stored.

For example, the processor may be configured to execute the function using the database where the similarities of each of the note contents and the words describing non-text elements included in the note contents are stored.

As described above, in an example embodiment, a method of an electronic device comprising a display, memory and a processor is provided. The method may comprise receiving a user input to search note contents stored in the memory. The user input may include at least one of texts input through a virtual keyboard and a path of an external object dragged on the display. The method may comprise, based on identifying a first text from the user input, determining one or more second texts indicated as associated with the first text using a language model representing a relationship between words. The method may comprise, based on identifying one or more paths from the user input, determining feature information of the one or more paths. The method may comprise, using at least one of the one or more second texts or the feature information, executing a function to search a database associated with the note contents. The method may comprise, in response to at least one note content matched to the user input which is identified based on execution of the function, displaying, on the display, a screen providing the at least one note content.

For example, the executing may comprise executing the function using levels where the note contents are associated with each of a plurality of categories, wherein the levels are stored in the database.

For example, the executing may comprise executing the function by accessing the database based on the categories which are determined by clustering the note contents using a text element and a non-text element included in each of the note contents.

For example, the executing may comprise determining similarities of each of the categories with respect to the third text by comparing a feature vector corresponding to a third text represented by the one or more paths included in the feature information and cluster vectors of each of the categories. The method may comprise determining scores of each of the note contents with respect to the third text based on the similarities and the levels. The method may comprise identifying the at least one note content matched to the user input among the note contents using the scores.

For example, the executing may comprise executing the function using the feature information indicating an appearance of a character or a figure which is represented by the one or more paths.

For example, the determining the one or more second texts may comprise, by accessing the language model using the first text, determining the one or more second texts where the at least one character is replaced among a plurality of characters which are serially connected to each other within the first text.

For example, the determining the one or more second texts may comprise searching the one or more note content associated with at least one of the first text or the one or more texts using the database where similarities of each of the note contents and words recognized from the note content are stored.

For example, the executing may comprise executing the function using the database where the similarities of each of the note contents and the words describing non-text elements included in the note contents are stored.

As described above, an electronic device according to an example embodiment may comprise a display, memory, and a processor. The processor may be configured to receive a user input to search a plurality of note contents stored in the memory using a first word. The processor may be configured to determine one or more second words where at least one character included in the first word is replaced using a language model representing a relationship between words. The processor may be configured to execute a function to search at least one note content among the plurality of note contents including at least one of the first word or the one or more second words represented by texts or one or more strokes. The processor may be configured to display, on the display, a screen providing the identified at least one note content based on execution of the function.

For example, the processor may be configured to execute the function using a database including similarities between a plurality of note contents and third words obtained by recognizing one or more strokes included in the note contents.

For example, the processor may be configured to execute the function using a database including levels where the note contents are associated with each of a plurality of categories.

For example, the processor may be configured to execute the function using the database based on the categories which are determined by clustering the note contents using texts and one or more strokes included in each of the note contents.

As described above, in an example embodiment, a method of an electronic device comprising a display, memory and a processor is provided. The method may comprise receiving a user input to search a plurality of note contents stored in the memory using a first word. The method may comprise determining one or more second words where at least one character included in the first word is replaced using a language model representing relationships between words. The method may comprise executing a function to search at least one note content among the plurality of note contents including at least one of the first word or the one or more second words represented by texts or one or more strokes. The method may comprise displaying, on the display, a screen providing the identified at least one note content based on execution of the function.

For example, the executing may comprise executing the function using a database including similarities between a plurality of note contents and third words obtained by recognizing a plurality of strokes included in the note contents.

For example, the executing may comprise executing the function using a database including levels where the note contents are associated with each of a plurality of categories.

For example, the executing may comprise executing the function using the database based on the categories which are determined by clustering the note contents using texts and one or more strokes included in each of the note contents.

The device described above may be implemented as a hardware component, a software component, and/or a combination of a hardware component and a software component. For example, the devices and components described in the disclosure may be implemented using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a one skilled in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to an example embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although various example embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved. It will also be understood that any of the embodiments(s) described herein may be used in conjunction with any other embodiment(s) described herein.

No claim element is to be construed under the provisions of 35 U.S.C. § 112, sixth paragraph, unless the element is expressly recited using the phrase “means for“ or ”means.”

What is claimed is:

1. An electronic device, comprising:
a display;
memory comprising one or more storage media storing instructions; and
at least one processor, comprising processing circuitry, wherein at least one processor, individually and/or collectively, is configured to execute the instructions and to cause the electronic device to:
receive an input to search note contents stored in the memory, wherein the input includes at least one of texts input through a virtual keyboard and a path of an external object dragged on the display;
based on identifying a first text from the input, determine one or more second texts indicated as associated with the first text using a language model representing a relationship between words;
based on identifying one or more paths from the input, determine feature information of the one or more paths;
using at least one of the one or more second texts and/or the feature information, execute a function to search a database associated with the note contents; and
in response to at least one note content matched to the input identified based on execution of the function, display, on the display, a screen providing the at least one note content.

2. The electronic device of claim 1, wherein at least one processor, individually and/or collectively, is configured to cause the electronic device:
execute the function using levels where the note contents are associated with each of a plurality of categories, wherein the levels are stored in the database.

3. The electronic device of claim 2, wherein at least one processor, individually and/or collectively, is configured to cause the electronic device to:
execute the function by accessing the database based on the categories determined by clustering the note contents using a text element and a non-text element included in each of the note contents.

4. The electronic device of claim 2, wherein at least one processor, individually and/or collectively, is configured to cause the electronic device to:
determine similarities of each of the categories with respect to a third text by comparing a feature vector corresponding to the third text represented by the one or more paths included in the feature information and cluster vectors of each of the categories;
determine scores of each of the note contents with respect to the third text based on the similarities and the levels; and
identify the at least one note content matched to the input among the note contents using the scores.

5. The electronic device of claim 1, wherein at least one processor, individually and/or collectively, is configured to cause the electronic device to:
execute the function using the feature information indicating a character or an appearance of a figure which are represented by the one or more paths.

6. The electronic device of claim 1, wherein at least one processor, individually and/or collectively, is configured to cause the electronic device to:
by accessing the language model using the first text, determine the one or more second texts where at least one character among a plurality of characters serially connected to each other within the first text.

7. The electronic device of claim 1, wherein at least one processor, individually and/or collectively, is configured to cause the electronic device to:
search the at least one note content associated with at least one of the first text or the one or more second texts using the database where similarities of each of the note contes and words recognized from the note contents are stored.

8. The electronic device of claim 7, wherein at least one processor, individually and/or collectively, is configured to cause the electronic device to:
execute the function using the database where the similarities of each of the note contents and the words describing non-text elements included in the note contents are stored.

9. A method of operating an electronic device comprising a display, memory and at least one processor, comprising processing circuitry, the method comprising:
receiving an input to search note contents stored in the memory, wherein the input includes at least one of texts input through a virtual keyboard and a path of an external object dragged on the display;
based on identifying a first text from the input, determining one or more second texts indicated as associated with the first text using a language model representing a relationship between words;
based on identifying one or more paths from the input, determining feature information of the one or more paths;
using at least one of the one or more second texts and/or the feature information, executing a function to search a database associated with the note contents; and
in response to at least one note content matched to the input identified based on execution of the function, displaying, on the display, a screen providing the at least one note content.

10. The method of claim 9, wherein the executing comprises:
executing the function using levels where the note contents are associated with each of a plurality of categories, wherein the levels are stored in the database.

11. The method of claim 10, wherein the executing comprises:
executing the function by accessing the database based on the categories determined by clustering the note contents using a text element and a non-text element included in each of the note contents.

12. The method of claim 10, wherein the executing comprises:
determining similarities of each of the categories with respect to the third text by comparing a feature vector corresponding to a third text represented by the one or more paths included in the feature information and cluster vectors of each of the categories;
determining scores of each of the note contents with respect to the third text based on the similarities and the levels; and
identifying the at least one note content matched to the input among the note contents using the scores.

13. The method of claim 9, wherein the executing comprises:
executing the function using the feature information indicating a character or an appearance of a figure which are represented by the one or more paths.

14. The method of claim 9, wherein the determining the one or more second texts comprises:
by accessing the language model using the first text, determining the one or more second texts where the at least one character is replaced among a plurality of characters serially connected to each other within the first text.

15. The method of claim 9, wherein the determining the one or more second texts executing comprises:
searching the one or more note content associated with at least one of the first text or the one or more texts using the database where similarities of each of the note contents and words recognized from the note content are stored.

16. The method of claim 15, wherein the determining the one or more second texts executing comprises:
executing the function using the database where the similarities of each of the note contents and the words describing non-text elements included in the note contents are stored.

17. An electronic device, comprising:
a display;
memory; and
at least one processor, comprising processing circuitry, individually and/or collectively, configured to cause the electronic device to:
receive an input to search a plurality of note contents stored in the memory using a first word;
determine one or more second words where at least one character included in the first word is replaced using a language model representing a relationship between words;
execute a function to search at least one note content among the plurality of note contents including at least one of the first word and/or the one or more second words represented by texts or one or more strokes; and
display, on the display, a screen providing the identified at least one note content based on execution of the function.

18. The electronic device of claim 17, wherein at least one processor, individually and/or collectively, is configured to cause the electronic device to:
execute the function using a database including similarities between a plurality of note contents and third words obtained by recognizing one or more strokes included in the note contents.

19. The electronic device of claim 17, wherein at least one processor, individually and/or collectively, is configured to cause the electronic device to:
execute the function using a database including levels where the note contents are associated with each of a plurality of categories, wherein the levels are stored in the database.

20. The electronic device of claim 17, wherein at least one processor, individually and/or collectively, is configured to cause the electronic device to:
execute the function using the database based on the categories determined by clustering the note contents using texts and one or more strokes included in each of the note contents.
